SEQUENCE LISTING (6 sequences)

SEQ ID NO: 1 - protein, 109 aa, Bacillus licheniformis
ARYDDVLYFPASRYPETGAHISDAIKAGHADVCTIERSGADKRRQESLKGIPTKPGFDRDEWPMAMCEEGGKGASVRYVSSSDNRGAGSWVGNRLNGYADGTRILFIVQ

SEQ ID NO: 2 - protein, 109 aa, Bacillus subtilis
ASSYDKVLYFPLSRYPETGSHIRDAIAEGHPDICTIDDGADKRREESLKGIPTKPGYDRDEWPMAVCEEGGAGADVRYVTPSDNRGAGSWVGNQMSSYPDGTRVLFIVQ

SEQ ID NO: 3 - protein, 109 aa, Bacillus licheniformis
ARYDDILYFPASRYPETGAHISDAIKAGHSDVCTIERSGADKRRQESLKGIPTKPGFDRDEWPMAMCEEGGKGASVRYVSSSDNRGAGSWVGNRLSGFADGTRILFIVQ

SEQ ID NO: 4 - protein, 361 aa, Aggregatibacter actinomycetemcomitans
NCCVKGNSIYPQKTSTKQTGLMLDIARHFYSPEVIKSFIDTISLSGGNFLHLHFSDHENYAIESHLLNQRAENAVQGKDGIYINPYTGKPFLSYRQLDDIKAYAKAKGIELIPELDSPNHMTAIFKLVQKDRGVKYLQGLKSRQVDDEIDITNADSITFMQSLMSEVIDIFGDTSQHFHIGGDEFGYSVESNHEFITYANKLSYFLEKKGLKTRMWNDGLIKNTFEQINPNIEITYWSYDGDTQDKNEAAERRDMRVSLPELLAKGFTVLNYNSYYLYIVPKASPTFSQDAAFAAKDVIKNWDLGVWDGRNTKNRVQNTHEIAGAALSIWGEDAKALKDETIQKNTKSLLEAVIHKTNGDE

SEQ ID NO: 5 - protein, 204 aa, Aspergillus oryzae
KTGSGDSQSDPIKADLEVKGQSALPFDVDCWAILCKGAPNVLQRVNEKTKNSNRDRSGANKGPFKDPQKWGIKALPPKNPSWSAQDFKSPEEYAFASSLQGGTNAILAPVNLASQNSQGGVLNGFYSANKVAQFDPSKPQQTKGTWFQITKFTGAAGPYCKALGSNDKSVCDKNKNIAGDWGFDPAKWAYQYDEKNNKFNYVGK

SEQ ID NO: 6 - protein, 188 aa, Trichoderma harzianum
APAPMPTPPGIPTESSARTQLAGLTVAVAGSGTGYSRDLFPTWDAISGNCNAREYVLKRDGEGVQVNNACESQSGTWISPYDNASFTNASSLDIDHMVPLKNAWISGASSWTTAQREALANDVSRPQLWAVSASANRSKGDRSPDQWKPPLTSFYCTYAKSWIDVKSFYKLTITSAEKTALSSMLDTC

(19) United States
(12) Patent Application Publication
(10) Pub. No.: US 2017/0355933 A1
(43) Pub. Date: Dec. 14, 2017

(54) CLEANING COMPOSITIONS INCLUDING NUCLEASE ENZYME AND MALODOR REDUCTION MATERIALS

(71) Applicant: The Procter & Gamble Company, Cincinnati, OH (US)

(72) Inventors: Neil Joseph LANT, Newcastle upon Tyne (GB); Judith Ann HOLLINGSHEAD, Batavia, OH (US); Gayle Marie FRANKENBACH, Cincinnati, OH (US)

(21) Appl. No.: 15/613,377

(22) Filed: Jun. 5, 2017

Related U.S. Application Data
(60) Provisional application No. 62/347,669, filed on Jun. 9, 2016.

(51) Int. Cl. C11D 3/386; C11D 3/50; C11D 11/00; C11D 3/00; C11D 1/14; C11D 1/29; C11D 1/22

(52) U.S. Cl. CPC C11D 3/38636; C11D 1/29; C12Y 302/01052; C11D 3/50; C12Y 301/30002; C12Y 301/21001; C11D 1/22; C11D 3/0068; C11D 1/143; C11D 11/0017

(57) ABSTRACT

Cleaning compositions that include a nuclease enzyme and one or more malodor reduction materials. Methods of making and using such cleaning compositions. Use of malodor reduction materials.

### FIELD OF THE INVENTION

The present disclosure relates to cleaning compositions that include a nuclease enzyme and malodor reduction materials. The present disclosure also relates to methods of making and using such cleaning compositions. The present disclosure also relates to the use of malodor reduction materials.

### BACKGROUND OF THE INVENTION

The laundry detergent formulator is constantly aiming to improve the performance of detergent compositions, particularly on malodorous soils. Nuclease enzymes are useful in providing malodor-reducing benefits. In particular, it is believed that nuclease enzymes can help to loosen and/or release malodorous soils from a target surface. However, some malodors may remain.

There is a need for improved cleaning compositions that provide malodor-reducing benefits.

### SUMMARY OF THE INVENTION

The present disclosure relates to a cleaning composition that includes a nuclease enzyme and at least one malodor reduction material.

The present disclosure also relates to a method of cleaning a surface, preferably a textile, where the method includes mixing the cleaning composition according to the present disclosure with water to form an aqueous liquor and contacting a surface, preferably a textile, with the aqueous liquor in a laundering step.

The present disclosure also relates to the use of malodor reduction materials in a cleaning composition to enhance the malodor-reducing benefits of a nuclease enzyme.

### DETAILED DESCRIPTION OF THE INVENTION

The present disclosure relates to cleaning compositions that include a nuclease enzyme and malodor reduction materials. Without wishing to be bound by theory, it is believed that nuclease enzymes are effective at unlocking soil matrices on a target surface (such as a fabric). However, when they do so, malodorous materials can be released into the immediate environment, such as a wash liquor. These malodorous materials can find their way into the headspace during the washing process, particularly in handwash and/or semi-automatic process, leading to an unpleasant washing experience for the consumer. Malodor reduction materials in combination with nucleases can improve the washing experience and overall performance of the cleaning compositions by neutralizing the impact of such malodorous materials.

The components of the compositions and processes of the present disclosure are described in more detail below.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

As used herein “MORV” is the calculated malodor reduction value for a subject material. A material's MORV indicates such material's ability to decrease or even eliminate the perception of one or more malodors. For purposes of the present application, a material's MORV is calculated in accordance with method found in the test methods section of the present application.

As used herein, the term “perfume” does not include malodor reduction materials. Thus, the perfume portion of a composition does not include, when determining the perfume's composition, any malodor reduction materials found in the composition as such malodor reduction materials are described herein. In short, if a material has a malodor reduction value “MORV” that is within the range of the MORV recited in the subject claim, such material is a malodor reduction material for purposes of such claim.

As used herein “cleaning and/or treatment compositions” means products comprising fluid laundry detergents, fabric enhancers, laundry and/or rinse additives, fluid dishwashing detergents, fluid hard surface cleaning and/or treatment compositions, fluid toilet bowl cleaners that may or may not be contained in a unit dose delivery product all for consumer, agricultural, industrial or institutional use.

As used herein, “malodor” refers to compounds generally offensive or unpleasant to most people, such as the complex odors associated with bowel movements.

As used herein, “odor blocking” refers to the ability of a compound to dull the human sense of smell.

As used herein, the term “alkoxy” is intended to include C1-C8 alkoxy and C1-C8 alkoxy derivatives of polyols having repeating units such as butylene oxide, glycidol oxide, ethylene oxide or propylene oxide.

As used herein, unless otherwise specified, the terms “alkyl” and “alkyl capped” are intended to include C1-C18 alkyl groups, or even C1-C6 alkyl groups.

As used herein, unless otherwise specified, the term “aryl” is intended to include C3-12 aryl groups.

As used herein, unless otherwise specified, the term “arylalkyl” and “alkaryl” are equivalent and are each intended to include groups comprising an alkyl moiety bound to an aromatic moiety, typically having C1-C18 alkyl groups and, in one aspect, C1-C6 alkyl groups.

The terms “ethylene oxide,” “propylene oxide” and “butylene oxide” may be shown herein by their typical designation of “EO,” “PO” and “BO,” respectively.

As used herein, the term “cleaning and/or treatment composition” includes, unless otherwise indicated, granular, powder, liquid, gel, paste, unit dose, bar form and/or flake type washing agents and/or fabric treatment compositions, including but not limited to products for laundering fabrics, fabric softening compositions, fabric enhancing compositions, fabric freshening compositions, and other products for the care and maintenance of fabrics, and combinations thereof. Such compositions may be pre-treatment compositions for use prior to a washing step or may be rinse added compositions, as well as cleaning auxiliaries, such as bleach additives and/or “stain-stick” or pre-treat compositions or substrate-laden products such as dryer added sheets.

As used herein, “cellulosic substrates” are intended to include any substrate which comprises cellulose, either 100% by weight cellulose or at least 20% by weight, or at least 30% by weight or at least 40% or at least 50% by weight or even at least 60% by weight cellulose. Cellulose may be found in wood, cotton, linen, jute, and hemp. Cellulosic substrates may be in the form of powders, fibers, pulp and articles formed from powders, fibers and pulp. Cellulosic fibers, include, without limitation, cotton, rayon (regenerated cellulose), acetate (cellulose acetate), triacetate (cellulose triacetate), and mixtures thereof. Typically cellulosic substrates comprise cotton. Articles formed from cellulosic fibers include textile articles such as fabrics. Articles formed from pulp include paper.

As used herein, the term “maximum extinction coefficient” is intended to describe the molar extinction coefficient at the wavelength of maximum absorption (also referred to herein as the maximum wavelength), in the range of 400 nanometers to 750 nanometers.

As used herein “average molecular weight” is reported as a weight average molecular weight, as determined by its molecular weight distribution; as a consequence of their manufacturing process, polymers disclosed herein may contain a distribution of repeating units in their polymeric moiety.

As used herein the term “variant” refers to a polypeptide that contains an amino acid sequence that differs from a wild type or reference sequence. A variant polypeptide can differ from the wild type or reference sequence due to a deletion, insertion, or substitution of a nucleotide(s) relative to said reference or wild type nucleotide sequence. The reference or wild type sequence can be a full-length native polypeptide sequence or any other fragment of a full-length polypeptide sequence. A polypeptide variant generally has at least about 70% amino acid sequence identity with the reference sequence, but may include 75% amino acid sequence identity within the reference sequence, 80% amino acid sequence identity within the reference sequence, 85% amino acid sequence identity with the reference sequence, 86% amino acid sequence identity with the reference sequence, 87% amino acid sequence identity with the reference sequence, 88% amino acid sequence identity with the reference sequence, 89% amino acid sequence identity with the reference sequence, 90% amino acid sequence identity with the reference sequence, 91% amino acid sequence identity with the reference sequence, 92% amino acid sequence identity with the reference sequence, 93% amino acid sequence identity with the reference sequence, 94% amino acid sequence identity with the reference sequence, 95% amino acid sequence identity with the reference sequence, 96% amino acid sequence identity with the reference sequence, 97% amino acid sequence identity with the reference sequence, 98% amino acid sequence identity with the reference sequence, 98.5% amino acid sequence identity with the reference sequence or 99% amino acid sequence identity with the reference sequence.

As used herein, the term “solid” includes granular, powder, bar and tablet product forms.

As used herein, the term “fluid” includes liquid, gel, paste, and gas product forms.

### Cleaning Composition

The present disclosure relates to cleaning compositions. The cleaning composition may be selected from the group of light duty liquid detergents compositions, heavy duty liquid detergent compositions, hard surface cleaning compositions, detergent gels commonly used for laundry, bleaching compositions, laundry additives, fabric enhancer compositions, shampoos, body washes, other personal care compositions, and mixtures thereof. The cleaning composition may be a hard surface cleaning composition (such as a dishwashing composition) or a laundry composition (such as a heavy duty liquid detergent composition).

The cleaning compositions may be in any suitable form. The composition can be selected from a liquid, solid, or combination thereof. As used herein, “liquid” includes free-flowing liquids, as well as pastes, gels, foams and mousses. Non-limiting examples of liquids include light duty and heavy duty liquid detergent compositions, fabric enhancers, detergent gels commonly used for laundry, bleach and laundry additives. Gases, e.g., suspended bubbles, or solids, e.g. particles, may be included within the liquids. A “solid” as used herein includes, but is not limited to, powders, agglomerates, and mixtures thereof. Non-limiting examples of solids include: granules, micro-capsules, beads, noodles, and pearlised balls. Solid compositions may provide a technical benefit including, but not limited to, through-the-wash benefits, pre-treatment benefits, and/or aesthetic effects.

The cleaning composition may be in the form of a unitized dose article, such as a tablet or in the form of a pouch. Such pouches typically include a water-soluble film, such as a polyvinyl alcohol water-soluble film, that at least partially encapsulates a composition. Suitable films are available from MonoSol, LLC (Indiana, USA). The composition can be encapsulated in a single or multi-compartment pouch. A multi-compartment pouch may have at least two, at least three, or at least four compartments. A multi-compartmented pouch may include compartments that are side-by-side and/or superposed. The composition contained in the pouch may be liquid, solid (such as powders), or combinations thereof.

### Nuclease Enzyme

The nuclease enzyme is an enzyme capable of cleaving the phosphodiester bonds between the nucleotide sub-units of nucleic acids. The nuclease enzyme herein is preferably a deoxyribonuclease or ribonuclease enzyme or a functional fragment thereof. By functional fragment or part is meant the portion of the nuclease enzyme that catalyzes the cleavage of phosphodiester linkages in the DNA backbone and so is a region of said nuclease protein that retains catalytic activity. Thus it includes truncated, but functional versions, of the enzyme and/or variants and/or derivatives and/or homologues whose functionality is maintained.

Preferably the nuclease enzyme is a deoxyribonuclease, preferably selected from any of the classes E.C. 3.1.21.x, where x=1, 2, 3, 4, 5, 6, 7, 8 or 9, E.C. 3.1.22.y where y=1, 2, 4 or 5, E.C. 3.1.30.z where z=1 or 2, E.C. 3.1.31.1 and mixtures thereof.

Nucleases in class E.C. 3.1.21.x cleave at the 3′ hydroxyl to liberate 5′ phosphomonoesters as follows:

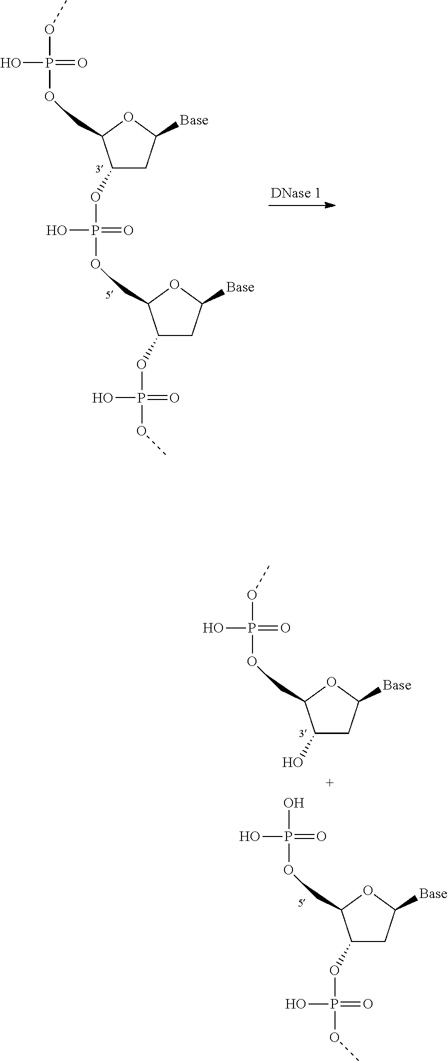

Nuclease enzymes from class E.C. 3.1.21.x and especially where x=1 are particularly preferred.

Nucleases in class E.C. 3.1.22.y cleave at the 5′ hydroxyl to liberate 3′ phosphomonoesters. Enzymes in class E.C. 3.1.30.z may be preferred as they act on both DNA and RNA and liberate 5′-phosphomonoesters. Suitable examples from class E.C. 3.1.31.2 are described in US2012/0135498A, such as SEQ ID NO:3 therein. Such enzymes are commercially available as DENARASE® enzyme from c-LECTA.

Nuclease enzymes from class E.C. 3.1.31.1 produce 3′phosphomonoesters.

Preferably, the nuclease enzyme comprises a microbial enzyme. The nuclease enzyme may be fungal or bacterial in origin. Bacterial nucleases may be most preferred. Fungal nucleases may be most preferred.

The microbial nuclease is obtainable from Bacillus, such as a Bacillus licheniformis or Bacillus subtilis bacterial nucleases. A preferred nuclease is obtainable from Bacillus licheniformis, preferably from strain EI-34-6. A preferred deoxyribonuclease is a variant of Bacillus licheniformis, from strain EI-34-6 nucB deoxyribonuclease defined in SEQ ID NO:1 herein, or variant thereof, for example having at least 70% or 75% or 80% or 85% or 90% or 95%, 96%, 97%, 98%, 99% or 100% identical thereto.

Other suitable nucleases are defined in SEQ ID NO:2 herein, or variant thereof, for example having at least 70% or 75% or 80% or 85% or 90% or 95%, 96%, 97%, 98%, 99% or 100% identical thereto. Other suitable nucleases are defined in SEQ ID NO:3 herein, or variant thereof, for example having at least 70% or 75% or 80% or 85% or 90% or 95%, 96%, 97%, 98%, 99% or 100% identical thereto.

A fungal nuclease is obtainable from Aspergillus, for example Aspergillus oryzae. A preferred nuclease is obtainable from Aspergillus oryzae defined in SEQ ID NO: 5 herein, or variant thereof, for example having at least 60% or 70% or 75% or 80% or 85% or 90% or 95%, 96%, 97%, 98%, 99% or 100% identical thereto.

Another suitable fungal nuclease is obtainable from Trichoderma, for example Trichoderma harzianum. A preferred nuclease is obtainable from Trichoderma harzianum defined in SEQ ID NO: 6 herein, or variant thereof, for example having at least 60% or 70% or 75% or 80% or 85% or 90% or 95%, 96%, 97%, 98%, 99% or 100% identical thereto.

Other fungal nucleases include those encoded by the DNA sequences of Aspergillus oryzae RIB40, Aspergillus oryzae 3.042, Aspergillus flavus NRRL3357, Aspergillus parasiticus SU-1, Aspergillus nomius NRRL13137, Trichoderma reesei QM6a, Trichoderma virens Gv29-8, Oidiodendron maius Zn, Metarhizium guizhouense ARSEF 977, Metarhizium majus ARSEF 297, Metarhizium robertsii ARSEF 23, Metarhizium acridum CQMa 102, Metarhizium brunneum ARSEF 3297, Metarhizium anisopliae, Colletotrichum fioriniae PJ7, Colletotrichum sublineola, Trichoderma atroviride IMI 206040, Tolypocladium ophioglossoides CBS 100239, Beauveria bassiana ARSEF 2860, Colletotrichum higginsianum, Hirsutella minnesotensis 3608, Scedosporium apiospermum, Phaeomoniella chlamydospora, Fusarium verticillioides 7600, Fusarium oxysporum f. sp. cubense race 4, Colletotrichum graminicola M1.001, Fusarium oxysporum FOSC 3-a, Fusarium avenaceum, Fusarium langsethiae, Grosmannia clavigera kw1407, Claviceps purpurea 20.1, Verticillium longisporum, Fusarium oxysporum f. sp. cubense race 1, Magnaporthe oryzae 70-15, Beauveria bassiana D1-5, Fusarium pseudograminearum CS3096, Neonectria ditissima, Magnaporthiopsis poae ATCC 64411, Cordyceps militaris CM01, Marssonina brunnea f. sp. ‘multigermtubi’ MB_ml, Diaporthe ampelina, Metarhizium album ARSEF 1941, Colletotrichum gloeosporioides Nara gc5, Madurella mycetomatis, Metarhizium brunneum ARSEF 3297, Verticillium alfalfae VaMs.102, Gaeumannomyces graminis var. tritici R3-111a-1, Nectria haematococca mpVI 77-13-4, Verticillium longisporum, Verticillium dahliae VdLs.17, Torrubiella hemipterigena, Verticillium longisporum, Verticillium dahliae VdLs.17, Botrytis cinerea B05.10, Chaetomium globosum CBS 148.51, Metarhizium anisopliae, Stemphylium lycopersici, Sclerotinia borealis F-4157, Metarhizium robertsii ARSEF 23, Myceliophthora thermophila ATCC 42464, Phaeosphaeria nodorum SN15, Phialophora attae, Ustilaginoidea virens, Diplodia seriata, Ophiostoma piceae UAMH 11346, Pseudogymnoascus pannorum VKM F-4515 (FW-2607), Bipolaris oryzae ATCC 44560, Metarhizium guizhouense ARSEF 977, Chaetomium thermophilum var. thermophilum DSM 1495, Pestalotiopsis fici W106-1, Bipolaris zeicola 26-R-13, Setosphaeria turcica Et28A, Arthroderma otae CBS 113480 and Pyrenophora tritici-repentis Pt-1C-BFP.

Preferably the nuclease is an isolated nuclease.

Preferably the nuclease enzyme is present in a the laundering aqueous solution in an amount of from 0.01 ppm to 1000 ppm of the nuclease enzyme, or from 0.05 or from 0.1 ppm to 750 or 500 ppm.

The nucleases may also give rise to biofilm-disrupting effects.

In a preferred composition, the composition additionally comprises a 13-N-acetylglucosaminidase enzyme from E.C. 3.2.1.52, preferably an enzyme having at least 70%, or at least 75% or at least 80% or at least 85% or at least 90% or at least 95% or at least 96% or at least 97% or at least 98% or at least 99% or at least or 100% identity to SEQ ID NO:4.

Malodor Reduction Materials

The cleaning compositions of the present disclosure comprise malodour reduction materials. As described above, such materials are capable of decreasing or even eliminating the perception of one or more malodors. These materials can be characterized by a calculated malodor reduction value (“MORV”), which is calculated according to the test method shown below.

As used herein “MORV” is the calculated malodor reduction value for a subject material. A material's MORV indicates such material's ability to decrease or even eliminate the perception of one or more malodors. For purposes of the present application, a material's MORV is calculated in accordance with method found in the test methods section of the present application.

The cleaning compositions of the present disclosure may comprise a sum total of from about 0.00025% to about 0.5%, preferably from about 0.0025% to about 0.1%, more preferably from about 0.005% to about 0.075%, most preferably from about 0.01% to about 0.05%, by weight of the composition, of 1 or more malodor reduction materials. The cleaning composition may comprise from about 1 to about 20 malodor reduction materials, more preferably 1 to about 15 malodor reduction materials, most preferably 1 to about 10 malodor reduction materials.

One, some, or each of the malodor reduction materials may have a MORV of at least 0.5, preferably from 0.5 to 10, more preferably from 1 to 10, most preferably from 1 to 5. One, some, or each of the malodor reduction materials may have a Universal MORV, defined as all of the MORV values of >0.5 for the malodors tested as described herein. The sum total of malodor reduction materials may have a Blocker Index of less than 3, more preferable less than about 2.5, even more preferably less than about 2, and still more preferably less than about 1, and most preferably about 0. The sum total of malodor reduction materials may have a Blocker Index average of from about 3 to about 0.001.

In the cleaning compositions of the present disclosure, the malodor reduction materials may have a Fragrance Fidelity Index of less than 3, preferably less than 2, more preferably less than 1 and most preferably about 0 and/or a Fragrance Fidelity Index average of 3 to about 0.001 Fragrance Fidelity Index. As the Fragrance Fidelity Index decreases, the malodor reduction material(s) provide less and less of a scent impact, while continuing to counteract malodors.

The cleaning compositions of the present disclosure may comprise a perfume. The weight ratio of parts of malodor reduction composition to parts of perfume may be from about 1:20,000 to about 3000:1, preferably from about 1:10,000 to about 1,000:1, more preferably from about 5,000:1 to about 500:1, and most preferably from about 1:15 to about 1:1. As the ratio of malodor reduction composition to parts of perfume is tightened, the malodor reduction material(s) provide less and less of a scent impact, while continuing to counteract malodors.

The cleaning compositions may comprise one or more malodor reduction materials having a log P greater than 3, preferably greater than 3 but less than 8. The one or more malodor reduction materials may be selected from the group consisting of Table 1 materials 7; 14; 39; 48; 183; 206; 212; 215; 229; 248; 260; 261; 329; 335; 360; 441; 484; 487; 488; 501; 566; 567; 569; 570; 573; 574; 603; 616; 621; 624; 632; 663; 680; 684; 694; 696; 708; 712; 714; 726; 750; 775; 776; 788; 804; 872; 919; 927; 933; 978; 1007; 1022; 1024; 1029; 1035; 1038; 1060; 1089; 1107; 1129; 1131; 1136; 1137; 1140; 1142; 1143; 1144; 1145; 1148, 1149 and mixtures thereof, most preferably said material is selected from the group consisting of Table 1 materials 261; 680; 788; 1129, 1148, 1149 and mixtures thereof. All of the aforementioned materials have a log P that is equal to or greater than 3, thus they deposit through the wash especially well. The more preferred and most preferred of the aforementioned material are particularly preferred as they are effective at counteracting all of the key malodors.

The cleaning compositions described herein may comprise one or more malodor reduction materials having a vapor pressure of greater than about 0.01 torr, preferably greater than about 0.01 torr to about 10 torr. The one or more malodor materials may be selected from the group consisting of Table 1 materials 7; 229; 281; 441; 603; 621; 627; 632; 696; 708; 714; 750; 1060; 1137; 1144; 1145 and mixtures thereof. All of the aforementioned materials have a vapor pressure that is greater than 0.01 torr, thus they effectively saturate the head space of a cleaning and/or treatment composition, wash solutions comprising same and a treated situs which leads to malodor blocking of any malodors in the cleaning and/or treatment composition, wash solutions comprising same and a treated situs. The more preferred and most preferred of the aforementioned material are particularly preferred as they are effective at counteracting all of the key malodors.

A non-limiting set of suitable malodor reduction materials are provided in Table 1 below. The cleaning compositions described herein may comprise a malodor reduction material selected from any of the materials listed in Table 1, or combinations thereof. For ease of reference herein, each material in Table 1 is assigned a numerical identifier which is found in the column for each table that is designated Number. Additional characteristics are provided in Table 1 according to the Comment Codes key shown below. Additional materials and corresponding characteristics are listed, for example, in US Patent Publication No. 2016/0090555 (assigned to The Procter & Gamble Company).

TABLE 1
List of materials with ALL MORVs >0.5

| Number | Material Name | CAS Number | Comment Code |
|---|---|---|---|
| 2 | 2,4-dimethyl-2-(5,5,8,8-tetramethyl- | 131812-67-4 | DFHJ |
| | 5,6,7,8-tetrahydronaphthalen-2-yl)-1,3- | | |
| | dioxolane | | |
| 7 | 3-methoxy-7,7-dimethyl-10- | 216970-21-7 | BDEFHJK |
| | methylenebicyclo[4.3.1]decane | | |
| 13 | Oxybenzone | 131-57-7 | DEFGJ |
| 14 | Oxyoctaline formate | 65405-72-3 | DFHJK |
| 23 | 3a,5,6,7,8,8b-hexahydro-2,2,6,6,7,8,8- | 823178-41-2 | DEFHJK |
| | heptamethyl-4H-indeno(4,5-d)-1,3- | | |
| | dioxole | | |
| 39 | 2,2,6,8-tetramethyl-1,2,3,4,4a,5,8,8a- | 103614-86-4 | DEFHIJK |
| | octahydronaphthalen-1-ol | | |
| 48 | Nootkatone | 4674-50-4 | DHJK |
| 65 | 1-ethyl-3- | 31996-78-8 | ACEFHIJKL |
| | methoxytricyclo[2.2.1.02,6]heptane | | |
| 68 | 10-isopropyl-2,7-dimethyl-1- | 89079-92-5 | BDEFHIJK |
| | oxaspiro[4.5]deca-3,6-diene | | |
| 100 | Methyl stearate | 112-61-8 | DEFHJ |
| 105 | Methyl linoleate | 112-63-0 | DEFHJ |
| 108 | Methyl isoeugenol | 93-16-3 | ACEFHK |
| 110 | Methyl eugenol | 93-15-2 | ACEFHK |
| 141 | 2,4-dimethyl-4,4a,5,9b- | 27606-09-3 | CEFHJK |
| | tetrahydroindeno[1,2-d][1,3]dioxine | | |
| 143 | 4-(4-hydroxy-4-methylpentyl)cyclohex- | 31906-04-4 | CHJ |
| | 3-ene-1-carbaldehyde | | |
| 146 | (Z)-3-hexen-1-yl-2-cyclopenten-1-one | 53253-09-1 | BDHK |
| 161 | (2,5-dimethyl-1,3-dihydroinden-2- | 285977-85-7 | CEFHJK |
| | yl)methanol | | |
| 183 | Khusimol | 16223-63-5 | CEFHJK |
| 185 | (1-methyl-2-((1,2,2- | 198404-98-7 | DEFHJK |
| | trimethylbicyclo[3.1.0]hexan-3- | | |
| | yl)methyl)cyclopropyl)methanol | | |
| 192 | 2,6,9,10-tetramethyl-1- | 71078-31-4 | BDEFHIJK |
| | oxaspiro(4.5)deca-3,6-diene | | |
| 195 | Isopropyl palmitate | 142-91-6 | DEFHJ |
| 199 | Isopimpinellin | 482-27-9 | CFGJ |
| 206 | Iso3-methylcyclopentadecan-1-one | 3100-36-5 | DEFGJK |
| 212 | Isoeugenyl benzyl ether | 120-11-6 | DFHJ |
| 215 | 1-((2S,3S)-2,3,8,8-tetramethyl- | 54464-57-2 | DHJK |
| | 1,2,3,4,5,6,7,8-octahydronaphthalen-2- | | |
| | yl)ethan-1-one | | |
| 227 | Isobornylcyclohexanol | 68877-29-2 | DEFHJK |
| 228 | Isobornyl propionate | 2756-56-1 | BDEFHIJK |
| 229 | Isobornyl isobutyrate | 85586-67-0 | BDEFHIJK |
| 230 | Isobornyl cyclohexanol | 66072-32-0 | DEFHJK |
| 233 | Isobergamate | 68683-20-5 | DEFHJK |
| 248 | Hydroxymethyl isolongifolene | 59056-64-3 | BDEFHJK |
| 260 | 2,3-dihydro-3,3-dimethyl-1H-indene-5- | 173445-44-8 | DHJK |
| | propanal | | |
| 261 | 3-(3,3-dimethyl-2,3-dihydro-1H-inden-5- | 173445-65-3 | DHJK |
| | yl)propanal | | |
| 281 | 3a,4,5,6,7,7a-hexahydro-1H-4,7- | 5413-60-5 | CEFGJK |
| | methanoinden-6-yl acetate | | |
| 292 | Guaiol | 489-86-1 | DEFHJK |
| 322 | gamma-Muurolene | 30021-74-0 | DEFHJKL |
| 325 | gamma-Himachalene | 53111-25-4 | BDEFHJKL |
| 329 | gamma-Eudesmol | 1209-71-8 | DFHJK |
| 333 | gamma-Cadinene | 39029-41-9 | DEFHJKL |
| 335 | 4,6,6,7,8,8-hexamethyl-1,3,4,6,7,8- | 1222-05-5 | DEFHJK |
| | hexahydrocyclopenta[g]isochromene | | |
| 343 | 8,8-dimethyl-3a,4,5,6,7,7a-hexahydro- | 76842-49-4 | DEFHJK |
| | 1H-4,7-methanoinden-6-yl propionate | | |
| 353 | (Z)-6-ethylideneoctahydro-2H-5,8- | 69486-14-2 | CEFGJK |
| | methanochromen-2-one | | |
| 359 | (E)-4-((3aR,4R,7R,7aR)-1,3a,4,6,7,7a- | 501929-47-1 | DEFHJK |
| | hexahydro-5H-4,7-methanoinden-5- | | |
| | ylidene)-3-methylbutan-2-ol | | |
| 360 | 8,8-dimethyl-3a,4,5,6,7,7a-hexahydro- | 171102-41-3 | DEFHJK |
| | 1H-4,7-methanoinden-6-yl acetate | | |
| 361 | 3-(4-ethylphenyl)-2,2- | 134123-93-6 | DEFHJK |
| | dimethylpropanenitrile | | |
| 371 | 1-cyclopentadec-4-en-1-one | 14595-54-1 | DEFGJK |
| 372 | 1-cyclopentadec-4-en-1-one | 35720-57-1 | DEFGJK |
| 374 | Eugenyl acetate | 93-28-7 | CFHJK |
| 413 | 6-ethyl-2,10,10-trimethyl-1- | 79893-63-3 | BDEFHIJK |
| | oxaspiro[4.5]deca-3,6-diene | | |
| 418 | (E)-4-((3aS,7aS)-octahydro-5H-4,7- | 30168-23-1 | DFHJK |
| | methanoinden-5-ylidene)butanal | | |
| 441 | Octahydro-1H-4,7-methanoinden-5-yl | 64001-15-6 | DEFHJKL |
| | acetate | | |
| 465 | delta-Cadinene | 483-76-1 | DEFHJKL |
| 467 | delta-Amorphene | 189165-79-5 | DEFHJKL |
| 472 | Decyl anthranilate | 18189-07-6 | DEFHJ |
| 484 | 3a,4,5,6,7,7a-hexahydro-1H-4,7- | 113889-23-9 | DEFHJK |
| | methanoinden-6-yl butyrate | | |
| 487 | 3a,4,5,6,7,7a-hexahydro-1H-4,7- | 67634-20-2 | DEFHJK |
| | methanoinden-5-yl isobutyrate | | |
| 488 | Curzerene | 17910-09-7 | DHJK |
| 501 | (E)-cycloheptadec-9-en-1-one | 542-46-1 | DEFGJ |
| 526 | (Z)-3-methyl-2-(pent-2-en-1- | 488-10-8 | BCHIJKL |
| | yl)cyclopent-2-en-1-one | | |
| 559 | (E)-1-(2,6,6-trimethylcyclohex-2-en-1- | 79-78-7 | DHJK |
| | yl)hepta-1,6-dien-3-one | | |
| 561 | (3aR,5aR,9aR,9bR)-3a,6,6,9a- | 3738-00-9 | DEFHJK |
| | tetramethyldodecahydronaphtho[2,1- | | |
| | b]furan | | |
| 565 | Cedryl methyl ether | 19870-74-7 | ADEFHJK |
| 566 | Cedryl formate | 39900-38-4 | BDEFHJK |
| 567 | Cedryl acetate | 77-54-3 | DEFHJK |
| 568 | (4Z,8Z)-1,5,9-trimethyl-13- | 71735-79-0 | DFHJK |
| | oxabicyclo[10.1.0]trideca-4,8-diene | | |
| 569 | Cedrol | 77-53-2 | DEFHJK |
| 570 | 5-methyl-1-(2,2,3-trimethylcyclopent-3- | 139539-66-5 | DEFHJK |
| | en-1-yl)-6-oxabicyclo[3.2.1]octane | | |
| 571 | 5-methyl-1-(2,2,3-trimethylcyclopent-3- | 426218-78-2 | DFHJ |
| | en-1-yl)-6-oxabicyclo[3.2.1]octane | | |
| 572 | 1,1,2,3,3-pentamethyl-1,2,3,5,6,7- | 33704-61-9 | BDEFHIJK |
| | hexahydro-4H-inden-4-one | | |
| 573 | Caryophyllene alcohol acetate | 32214-91-8 | DEFHJK |
| 574 | Caryolan-1-ol | 472-97-9 | DEFHJK |
| 603 | Bornyl isobutyrate | 24717-86-0 | BDEFHIJK |
| 616 | beta-Santalol | 77-42-9 | DEFHJK |
| 621 | beta-Patchoulline | 514-51-2 | BDEFGJKL |
| 624 | beta-Himachalene Oxide | 57819-73-5 | BDFHJK |
| 625 | beta-Himachalene | 1461-03-6 | DEFHJKL |
| 626 | beta-Guaiene | 88-84-6 | DEFHJKL |
| 627 | (2,2-dimethoxyethyl)benzene | 101-48-4 | DHJK |
| 631 | beta-Copaene | 18252-44-3 | BDEFHJKL |
| 632 | beta-Cedrene | 546-28-1 | BDEFGJKL |
| 633 | beta-Caryophyllene | 87-44-5 | DEFHJKL |
| 638 | Bergaptene | 484-20-8 | CGJ |
| 644 | Benzyl laurate | 140-25-0 | DEFHJ |
| 659 | 2′-isopropyl-1,7,7- | 188199-50-0 | DEFHJK |
| | trimethylspiro[bicyclo[2.2.1]heptane- | | |
| | 2,4′-[1,3]dioxane] | | |
| 663 | Anisyl phenylacetate | 102-17-0 | DFHJ |
| 673 | (3aR,5aS,9aS,9bR)-3a,6,6,9a- | 6790-58-5 | DEFHJK |
| | tetramethyldodecahydronaphtho[2,1- | | |
| | b]furan | | |
| 674 | (4aR,5R,7aS,9R)-2,2,5,8,8,9a- | 211299-54-6 | DEFHJK |
| | hexamethyloctahydro-4H-4a,9- | | |
| | methanoazuleno[5,6-d][1,3]dioxole | | |
| 676 | 2,5,5-trimethyl-1,2,3,4,5,6,7,8- | 41199-19-3 | DEFHJK |
| | octahydronaphthalen-2-ol | | |
| 678 | (3S,5aR,7aS,11aS,11bR)-3,8,8,11a- | 57345-19-4 | DEFHJ |
| | tetramethyldodecahydro-5H-3,5a- | | |
| | epoxynaphtho[2,1-c]oxepine | | |
| 679 | 2,2,6,6,7,8,8-heptamethyldecahydro-2H- | 476332-65-7 | ADEFHJK |
| | indeno[4,5-b]furan | | |
| 680 | 2,2,6,6,7,8,8-heptamethyldecahydro-2H- | 647828-16-8 | ADEFHJK |
| | indeno[4,5-b]furan | | |
| 684 | alpha-Vetivone | 15764-04-2 | DHJK |
| 694 | alpha-Santalol | 115-71-9 | DEFHJK |
| 696 | alpha-Patchoulene | 560-32-7 | ADEFHJKL |
| 698 | alpha-Muurolene | 10208-80-7 | DEFHJKL |
| 700 | alpha-methyl ionone | 127-42-4 | BDHJK |
| 708 | alpha-Gurjunene | 489-40-7 | BDEFHJKL |
| 712 | alpha-Eudesmol | 473-16-5 | DEFHJK |
| 714 | alpha-Cubebene | 17699-14-8 | ADEFHJKL |
| 715 | alpha-Cedrene epoxide | 13567-39-0 | ADEFHJK |
| 716 | alpha-Cadinol | 481-34-5 | DEFHJK |
| 717 | alpha-Cadinene | 24406-05-1 | DEFHJKL |
| 718 | alpha-Bisabolol | 515-69-5 | DFHJK |
| 725 | alpha-Amorphene | 23515-88-0 | DEFHJKL |
| 726 | alpha-Agarofuran | 5956-12-7 | BDEFHJK |
| 750 | Allo-aromadendrene | 25246-27-9 | BDEFHJKL |
| 758 | Acetoxymethyl-isolongifolene (isomers) | 59056-62-1 | BDEFHJK |
| 764 | Acetarolle | 744266-61-3 | DFHJK |
| 769 | (Z)-2-(4-methylbenzylidene)heptanal | 84697-09-6 | DHJ |
| 775 | 7-eip-alpha-Eudesmol | 123123-38-6 | DEFHJK |
| 776 | 7-Acetyl-1,1,3,4,4,6-hexamethyltetralin | 1506-02-1 | DEFHJ |
| 788 | 5-Cyclohexadecenone | 37609-25-9 | DEFGJK |
| 803 | 4-(p-Methoxyphenyl)-2-butanone | 104-20-1 | BCEFHJK |
| 804 | 3-Thujopsanone | 25966-79-4 | BDEFHJK |
| 865 | 2,6-Nonadien-1-ol | 7786-44-9 | ACEFHK |
| 872 | 10-epi-gamma-Eudesmol | 15051-81-7 | DFHJK |
| 879 | 1,1,2,3,3-Pentamethylindan | 1203-17-4 | ADHIJKL |
| 893 | (2S,5S,6S)-2,6,10,10-tetramethyl-1- | 65620-50-0 | DFHIJK |
| | oxaspiro[4_5]decan-6-ol | | |
| 912 | 2-(8-isopropyl-6- | 68901-32-6 | DEFHJK |
| | methylbicyclo[2.2.2]oct-5-en-2-yl)-1,3- | | |
| | dioxolane | | |
| 919 | 3a,4,5,6,7,7a-hexahydro-1H-4,7- | 17511-60-3 | CEFHJK |
| | methanoinden-6-yl propionate | | |
| 920 | Bulnesol | 22451-73-6 | DEFHJK |
| 923 | Benzoin | 119-53-9 | CEFHJ |
| 927 | 5-Acetyl-1,1,2,3,3,6-hexamethylindan | 15323-35-0 | DEFHJK |
| 933 | Patchouli alcohol | 5986-55-0 | DEFHIJK |
| 948 | Perillyl alcohol | 536-59-4 | CHIJK |
| 959 | Phenethyl phenylacetate | 102-20-5 | DHJ |
| 962 | Phenoxanol | 55066-48-3 | DEFHJK |
| 978 | 3a,4,5,6,7,7a-hexahydro-1H-4,7- | 68039-44-1 | DEFHJK |
| | methanoinden-6-yl pivalate | | |
| 998 | p-Tolyl phenylacetate | 101-94-0 | DFHJ |
| 1007 | (2R,4a′R,8a′R)-3,7′-dimethyl- | 41816-03-9 | DEFHJK |
| | 3′,4′,4a′,5′,8′,8a′-hexahydro-1′H- | | |
| | spiro[oxirane-2,2′- | | |
| | [1,4]methanonaphthalene] | | |
| 1008 | (Z)-6-ethylideneoctahydro-2H-5,8- | 93939-86-7 | BCEFHJKL |
| | methanochromene | | |
| 1022 | 2,2,7,9-tetramethylspiro(5.5)undec-8-en- | 502847-01-0 | DHIJK |
| | 1-one | | |
| 1023 | 3-methyl-5-(2,2,3-trimethylcyclopent-3- | 65113-99-7 | DEFHJK |
| | en-1-yl)pentan-2-ol | | |
| 1024 | (Z)-2-ethyl-4-(2,2,3-trimethylcyclopent- | 28219-61-6 | DEFHJK |
| | 3-en-1-yl)but-2-en-1-ol | | |
| 1026 | 5-methoxyoctahydro-1H-4,7- | 86803-90-9 | CHJK |
| | methanoindene-2-carbaldehyde | | |
| 1027 | 5-methoxyoctahydro-1H-4,7- | 193425-86-4 | CHJK |
| | methanoindene-2-carbaldehyde | | |
| 1028 | Sclareol | 515-03-7 | DEFHJ |
| 1029 | Sclareol oxide | 5153-92-4 | DEFHJK |
| 1031 | Selina-3,7(11)-diene | 6813-21-4 | DEFHJKL |
| 1035 | Spathulenol | 6750-60-3 | DEFHJK |
| 1038 | 1-(spiro[4.5]dec-7-en-7-yl)pent-4-en-1- | 224031-70-3 | DGJK |
| | one | | |
| 1046 | tau-Cadinol | 5937-11-1 | DEFHJK |
| 1047 | tau-Muurolol | 19912-62-0 | DEFHJK |
| 1060 | Thujopsene | 470-40-6 | BDEFGJKL |
| 1063 | 1-(2,2,6-trimethylcyclohexyl)hexan-3-ol | 70788-30-6 | DEFHJK |
| 1089 | Tricyclone | 68433-81-8 | DEFHJK |
| 1093 | Methyl 2-((1-hydroxy-3- | 144761-91-1 | DFHJ |
| | phenylbutyl)amino)benzoate | | |
| 1097 | Decahydro-2,6,6,7,8,8-hexamethyl-2h- | 338735-71-0 | BDEFHJK |
| | indeno(4,5-b)furan | | |
| 1105 | Valencene | 4630-07-3 | BDEFHJK |
| 1107 | Valerianol | 20489-45-6 | DEFHJK |
| 1120 | 1-methoxy-3a,4,5,6,7,7a-hexahydro-1H- | 27135-90-6 | ACEFHJKL |
| | 4,7-methanoindene | | |
| 1129 | 1-((3R,3aR,7R,8aS)-3,6,8,8-tetramethyl- | 32388-55-9 | DHJK |
| | 2,3,4,7,8,8a-hexahydro-1H-3a,7- | | |
| | methanoazulen-5-yl)ethan-1-one | | |
| 1131 | Methyl (Z)-2-(((2,4-dimethylcyclohex-3- | 68738-99-8 | DEFHJ |
| | en-1-yl)methylene)amino)benzoate | | |
| 1135 | Vetiverol | 89-88-3 | CEFHIJK |
| 1136 | Vetivert Acetate | 117-98-6 | DEFHJK |
| 1137 | Decahydro-3H-spiro[furan-2,5′- | 68480-11-5 | DEFGJKL |
| | [4,7]methanoindene] | | |
| 1139 | (Z)-cyclooct-4-en-1-yl methyl carbonate | 87731-18-8 | BCHJKL |
| 1140 | (1aR,4S,4aS,7R,7aS,7bS)-1,1,4,7- | 552-02-3 | DEFHJK |
| | tetramethyldecahydro-1H- | | |
| | cyclopropalelazulen-4-ol | | |
| 1142 | 3,5,5,6,7,8,8-heptamethyl-5,6,7,8- | 127459-79-4 | DHJ |
| | tetrahydronaphthalene-2-carbonitrile | | |
| 1143 | (1S,2S,3S,5R)-2,6,6- | 133636-82-5 | DEFHJK |
| | trimethylspiro[bicyclo[3.1.1]heptane- | | |
| | 3,1′-cyclohexan]-2′-en-4′-one | | |
| 1144 | 1′,1′,5′,5′-tetramethylhexahydro- | 154171-76-3 | DEFHJK |
| | 2′H,5′H-spiro[[1,3]dioxolane-2,8′- | | |
| | [2,4a]methanonaphthalene] | | |
| 1145 | 1′,1′,5′,5′-tetramethylhexahydro- | 154171-77-4 | DEFHJK |
| | 2′H,5′H-spiro[[1,3]dioxolane-2,8′- | | |
| | [2,4a]methanonaphthalene] K | | |
| 1146 | 4-(4-hydroxy-3-methoxyphenyl)butan-2- | 122-48-5 | CEFGJ |
| | one | | |
| 1147 | (1R,8aR)-4-isopropyl-1,6-dimethyl- | 41929-05-9 | DEFHJKL |
| | 1,2,3,7,8,8a-hexahydronaphthalene | | |
| 1148 | 4,5-epoxy-4,11,11-trimethyl-8- | 1139-30-6 | DEFHJK |
| | methylenebicyclo(7.2.0)undecane | | |
| 1149 | 1,3,4,6,7,8alpha-hexahydro-1,1,5,5- | 23787-90-8 | DEFHIJK |
| | tetramethyl-2H-2,4alpha- | | |
| | methanophtalen-8(5H)-one | | |
| 1151 | 1-(2,2-dimethyl-6-methylen cyclohexyl)- | 64070-16-2 | CEFHJK |
| | 1-penten-3-one | | |

Comment Codes
A = Vapor Pressure > 0.1 torr
B = Vapor Pressure is between 0.01 torr and 0.1 torr
C = log P < 3
D = log P > 3
E = Probability of Ingredient Color Instability = 0%
F = Probability of Ingredient Color Instability < 71%
G = Odor Detection Threshold less than p.ol = 8
H = Odor Detection Threshold greater than p.ol = 8
I = Melamine formaldehyde PMC Headspace Response Ratio greater than or equal to 10
J = Melamine formaldehyde PMC leakage less than or equal to 5%
K = Log of liquid dish neat product liquid-air partition coefficient greater than or equal to −7
L = Log of liquid dish neat product liquid-air partition coefficient greater than or equal to −5

The materials in Table 1 can be supplied by one or more of the following: Firmenich Inc. of Plainsboro N.J. USA; International Flavor and Fragrance Inc. New York, N.Y. USA; Takasago Corp. Teterboro, N.J. USA; Symrise Inc. Teterboro, N.J. USA; Sigma-Aldrich/SAFC Inc. Carlsbad, Calif. USA; and Bedoukian Research Inc., Danbury, Conn. USA.

Table 2 shows the actual MORV values for each material listed in Table 1 above.

TABLE 2
Actual MORV values

| | MORV | | | MORV |
|---|---|---|---|---|
| Material | value for | MORV Value | MORV Value | value for |
| No. | Equation a.) | for Equation b.) | for Equation c.) | Equation d.) |
| 2 | 1.520311929 | 3.493450446 | 2.70657265 | 5.11342862 |
| 7 | 1.437444636 | 2.131822996 | 3.81633465 | 1.318339345 |
| 13 | 1.549643217 | 1.809183231 | 0.70864531 | 2.22799611 |
| 14 | 2.82111224 | 2.339505033 | 1.240818 | 2.502429355 |
| 23 | 3.702361074 | 1.399942641 | 5.23954766 | 7.089933671 |
| 39 | 1.083800659 | 2.069727985 | 2.48170879 | 3.205630609 |
| 48 | 2.370955056 | 2.783472865 | 2.68240273 | 1.221864405 |
| 65 | 0.972835178 | 2.797151284 | 1.53453579 | 0.857051645 |
| 68 | 0.527636614 | 0.590831983 | 1.02843762 | 2.208655795 |
| 100 | 1.654535066 | 0.995056228 | 2.35139085 | 0.543654824 |
| 105 | 1.654535066 | 3.654489674 | 3.13033965 | 0.544225478 |
| 108 | 0.532375207 | 0.826537134 | 1.21040312 | 0.690230716 |
| 110 | 0.54830833 | 2.916795026 | 1.40126098 | 0.690230716 |
| 141 | 2.067620311 | 1.424830396 | 2.33536931 | 7.644025075 |
| 143 | 1.736969725 | 0.991537809 | 2.5691601 | 1.227191656 |
| 146 | 1.912710035 | 0.926306508 | 1.81253333 | 0.494121361 |
| 161 | 0.475184006 | 1.99305646 | 1.90910177 | 3.288337059 |
| 183 | 3.195758563 | 3.886545621 | 4.29482769 | 3.829845293 |
| 185 | 5.61162203 | 1.40458529 | 2.86231343 | 1.035135749 |
| 192 | 0.65612864 | 1.231196814 | 0.75462061 | 1.514581532 |
| 195 | 1.18880856 | 0.704463775 | 1.99312777 | 1.419709023 |
| 199 | 1.493919434 | 1.45125612 | 1.95141371 | 4.403441058 |
| 206 | 2.147983695 | 1.291351958 | 1.64553247 | 1.626455601 |
| 212 | 1.367811201 | 1.689658923 | 1.8017376 | 2.525531645 |
| 215 | 2.264275088 | 1.360001278 | 3.25759951 | 2.147928282 |
| 227 | 5.317676982 | 2.824566654 | 1.73360625 | 3.103310061 |
| 228 | 3.323728685 | 1.554268023 | 1.8883835 | 0.957527434 |
| 229 | 3.218950175 | 1.464118271 | 2.47512497 | 1.214429025 |
| 230 | 5.242356467 | 3.482206715 | 3.50441556 | 1.614847073 |
| 233 | 1.312921486 | 0.816597603 | 2.17066283 | 0.472801294 |
| 248 | 5.81821686 | 6.320330665 | 6.14379552 | 5.214046447 |
| 260 | 2.4020693 | 2.669351733 | 2.36395771 | 1.910609499 |
| 261 | 1.978618006 | 2.732613301 | 2.19594212 | 1.683156477 |
| 281 | 2.201373139 | 2.228820089 | 2.03455575 | 1.720697243 |
| 292 | 1.2252731 | 0.720498276 | 4.33362953 | 2.202084022 |
| 322 | 0.956379568 | 2.838565742 | 2.7997689 | 0.805938034 |
| 325 | 0.791400443 | 2.454239197 | 1.54315324 | 1.416449646 |
| 329 | 1.800767509 | 1.372656013 | 2.09551175 | 2.849728342 |
| 333 | 0.956379568 | 2.838565742 | 2.7997689 | 0.805938034 |
| 335 | 1.931053264 | 2.306571877 | 4.45651797 | 4.474221307 |
| 343 | 3.375840967 | 3.294907583 | 5.0378352 | 4.14804591 |
| 353 | 2.347680291 | 1.432589328 | 3.81650185 | 2.28664738 |
| 359 | 3.169264285 | 2.326146291 | 5.44251947 | 3.621423972 |
| 360 | 2.824830639 | 3.29829616 | 3.43870859 | 3.771256974 |
| 361 | 0.772183137 | 0.62924397 | 1.14549597 | 0.743423792 |
| 371 | 1.933819902 | 0.975863726 | 1.62799441 | 1.492919426 |
| 372 | 1.933819902 | 0.975863726 | 1.62799441 | 1.492919426 |
| 374 | 0.940949346 | 2.935858163 | 0.52084392 | 0.847114052 |
| 413 | 0.630456164 | 1.538096427 | 2.10994563 | 2.45668637 |
| 418 | 3.678359573 | 3.437930194 | 4.42449746 | 0.716864637 |
| 441 | 2.349282571 | 1.734747324 | 1.71148239 | 1.274963632 |
| 465 | 0.940569103 | 1.267891616 | 1.68420132 | 1.263608034 |
| 467 | 0.940569103 | 1.267891616 | 1.68420132 | 1.263608034 |
| 472 | 0.605628283 | 0.938001104 | 0.50028363 | 0.743911872 |
| 484 | 3.269313083 | 2.336715633 | 3.65534824 | 2.158890088 |
| 487 | 2.889323404 | 2.226094104 | 4.12877599 | 2.184426542 |
| 488 | 1.062548487 | 4.75312035 | 2.78435853 | 2.01925207 |
| 501 | 1.992766 | 1.365055 | 1.774147 | 1.760818 |
| 526 | 0.698504484 | 0.548193178 | 0.92265651 | 0.500152973 |
| 559 | 1.433732801 | 2.854621121 | 1.81079379 | 0.893806123 |
| 561 | 1.874725149 | 0.921395625 | 3.05642524 | 2.616508159 |
| 565 | 3.655479783 | 3.751479035 | 5.51820797 | 3.282822615 |
| 566 | 4.034374094 | 3.755759834 | 4.82506006 | 3.190861648 |
| 567 | 4.203811008 | 3.627632534 | 4.68751919 | 3.372829008 |
| 568 | 1.643514525 | 0.827299302 | 0.70706274 | 2.545428997 |
| 569 | 2.692371513 | 3.589810155 | 4.40390088 | 4.506937878 |
| 570 | 1.707556133 | 2.400065573 | 1.78745169 | 2.655458557 |
| 571 | 1.862893827 | 2.803280605 | 0.98209954 | 3.188564781 |
| 572 | 1.203581368 | 0.798608763 | 2.67898788 | 1.659633314 |
| 573 | 2.459623568 | 2.656773866 | 3.54771795 | 2.085649266 |
| 574 | 2.878405284 | 1.770500246 | 4.00464111 | 4.859737959 |
| 603 | 3.218950175 | 1.464118271 | 2.47512497 | 1.214429025 |
| 616 | 2.689328335 | 3.692579375 | 2.01499213 | 1.348800283 |
| 621 | 3.671429366 | 1.708460032 | 4.57083156 | 1.955988764 |
| 624 | 2.139270802 | 2.093130621 | 2.5533383 | 3.30383102 |
| 625 | 0.665423108 | 1.356936283 | 1.5515704 | 1.874119646 |
| 626 | 1.292942787 | 0.621140137 | 2.28513785 | 1.042322574 |
| 627 | 1.14724223 | −0.51104438 | 1.01088446 | 1.51232276 |
| 631 | 2.622138509 | 5.106659136 | 4.48303003 | 2.115425367 |
| 632 | 2.450328692 | 4.670297017 | 4.54579766 | 2.15781135 |
| 633 | 1.560465308 | 2.636096631 | 2.45546606 | 0.920962489 |
| 638 | 1.921725015 | 0.758255259 | 0.81570609 | 3.615611357 |
| 644 | 0.85173251 | 0.664325682 | 1.88299246 | 0.951603698 |
| 659 | 3.996948911 | 1.915319951 | 3.03990612 | 5.764113617 |
| 663 | 1.521826905 | 1.097809988 | 2.13583044 | 1.30609234 |
| 673 | 1.874725149 | 0.921395625 | 3.05642524 | 2.616508159 |
| 674 | 5.912391366 | 3.468705262 | 6.81994671 | 7.217631788 |
| 676 | 0.623704257 | 1.523736626 | 2.50208859 | 2.474137331 |
| 678 | 4.818555677 | 1.506257638 | 4.96635528 | 5.508133385 |
| 679 | 4.332202737 | 2.699343437 | 5.65576391 | 5.021298111 |
| 680 | 4.042984412 | 4.75506829 | 4.65903898 | 4.913020939 |
| 684 | 2.349844428 | 1.181400632 | 2.15359469 | 2.136987013 |
| 694 | 4.858313721 | 4.772826468 | 3.58732214 | 2.558402204 |
| 696 | 2.99409154 | 3.843066736 | 2.50597637 | 1.205022789 |
| 698 | 0.983060431 | 2.328872529 | 1.67788951 | 0.805938034 |
| 700 | 0.698400489 | 0.514637899 | 1.14265307 | 0.816064314 |
| 708 | 2.391828225 | 1.877690145 | 3.85935427 | 1.647356195 |
| 712 | 1.936489942 | 2.528373237 | 2.13424487 | 2.393940425 |
| 714 | 2.3584433 | 3.778880151 | 3.4396901 | 1.593719007 |
| 715 | 4.023918591 | 3.403899942 | 5.07447567 | 4.880181625 |
| 716 | 0.981194248 | 1.73892162 | 2.21166953 | 2.738129365 |
| 717 | 0.983060431 | 2.328872529 | 1.67788951 | 0.805938034 |
| 718 | 1.241840746 | 3.430871861 | 0.55000978 | 1.073616332 |
| 725 | 0.983060431 | 2.328872529 | 1.67788951 | 0.805938034 |
| 726 | 2.887615733 | 3.282342953 | 1.95034945 | 2.462290186 |
| 750 | 2.554017714 | 3.544542579 | 4.42317523 | 1.647356195 |
| 758 | 5.933043009 | 5.716461604 | 6.67410554 | 4.433272782 |
| 764 | 1.695705 | 3.388013 | 2.181775 | 3.284744 |
| 769 | 1.889999468 | 1.112266205 | 0.82815523 | 0.525271623 |
| 775 | 1.936489942 | 2.528373237 | 2.13424487 | 2.393940425 |
| 776 | 1.495019673 | 4.35984375 | 2.59969954 | 2.95313487 |
| 788 | 2.147983695 | 1.250042565 | 1.72576392 | 1.626956379 |
| 803 | 1.706162052 | 0.623892414 | 0.59662073 | 0.7745661 |
| 804 | 3.478490379 | 2.348697011 | 3.96279011 | 2.456963386 |
| 865 | 1.670680003 | 1.916382859 | 0.6998144 | 1.124089601 |
| 872 | 1.800767509 | 1.372656013 | 2.09551175 | 2.849728342 |
| 879 | 1.187592149 | 1.464239711 | 0.67009263 | 1.103774764 |
| 893 | 0.869958847 | 0.843158237 | 0.61532515 | 3.158279932 |
| 912 | 0.530707518 | 0.774109528 | 3.0396125 | 4.394775258 |
| 919 | 2.891894151 | 2.295157633 | 3.54101626 | 1.984030826 |
| 920 | 1.292959895 | 0.808281618 | 2.92956952 | 2.204248324 |
| 923 | 1.340862559 | 0.503169303 | 0.53213093 | 3.164832031 |
| 927 | 1.879182741 | 3.409153142 | 2.48473663 | 3.409954437 |
| 933 | 3.702965303 | 3.03402795 | 4.33630831 | 4.238503729 |
| 948 | 0.592575441 | 1.383482681 | 0.93567635 | 1.058669028 |
| 959 | 1.609198886 | 0.500797943 | 0.795571 | 0.908389449 |
| 962 | 1.836429446 | 0.208275147 | −0.14300625 | 1.067462181 |
| 978 | 2.201759817 | 2.123549573 | 3.7881607 | 2.358768953 |
| 998 | 2.197271885 | 1.578871826 | 0.90563334 | 1.056619658 |
| 1007 | 4.040291133 | 3.474551355 | 3.57146797 | 3.565985043 |
| 1008 | 0.764519082 | 0.917635102 | 2.88258762 | 2.319622474 |
| 1022 | 1.364966718 | 1.690570939 | 2.05914194 | 2.364375484 |
| 1023 | 2.154641091 | 0.800066339 | 0.85365652 | 0.965810338 |
| 1024 | 2.302280068 | 1.252164308 | 1.73414439 | 1.549538352 |
| 1026 | 2.97722987 | 2.096441965 | 3.87172868 | 0.550274831 |
| 1027 | 2.474381478 | 1.950326182 | 3.81861867 | 1.366897355 |
| 1028 | 1.778414353 | 3.114931059 | 4.47690731 | 6.054314034 |
| 1029 | 3.672910795 | 2.760483725 | 3.26915034 | 3.042677588 |
| 1031 | 2.012732245 | 2.293857161 | 0.54405555 | 1.261882121 |
| 1035 | 2.506372295 | 3.419954592 | 4.58206882 | 4.134341651 |
| 1038 | 2.753559643 | 3.81185814 | 2.71344734 | 2.243351472 |
| 1046 | 0.981194248 | 1.73892162 | 2.21166953 | 2.738129365 |
| 1047 | 0.981194248 | 1.73892162 | 2.21166953 | 2.738129365 |
| 1060 | 3.311161199 | 3.074783921 | 2.10199297 | 1.822541682 |
| 1063 | 1.385675542 | 0.738759296 | 1.1677069 | 0.501211562 |
| 1089 | 2.769817302 | 1.661618789 | 3.97585272 | 1.059236597 |
| 1093 | 0.72304265 | 1.667011476 | 2.53982093 | 2.7903213 |
| 1097 | 4.407270402 | 2.670641491 | 5.02636153 | 5.361271976 |
| 1105 | 2.387326861 | 3.865456674 | 2.2251199 | 0.728667998 |
| 1107 | 2.352582059 | 2.595496601 | 3.20492728 | 2.844590737 |
| 1120 | 0.953790113 | 1.106552668 | 3.00006904 | 1.585038764 |
| 1129 | 3.18966648 | 3.284362987 | 4.49398568 | 3.950809104 |
| 1131 | 1.650621055 | 1.545704806 | 2.37535081 | 1.259373143 |
| 1135 | 0.626973385 | 1.998305877 | 2.61706075 | 1.570404253 |
| 1136 | 2.812199484 | 1.353198146 | 2.05618426 | 1.869204406 |
| 1137 | 2.208307057 | 1.387136198 | 3.21521374 | 2.069795393 |
| 1139 | 1.408517438 | 0.890457374 | 1.24524408 | 0.685687797 |
| 1140 | 2.765860952 | 2.525539595 | 4.12464228 | 3.833744077 |
| 1142 | 2.54335679 | 4.298105601 | 3.36234238 | 2.684404542 |
| 1143 | 4.204367611 | 3.062126931 | 3.4234313 | 2.072899554 |
| 1144 | 2.479165229 | 3.226545885 | 4.65897152 | 4.952127235 |
| 1145 | 2.479158921 | 3.226545885 | 4.65897152 | 4.952127235 |
| 1146 | 0.774334025 | 1.075800774 | 1.06893156 | 1.011113116 |
| 1147 | 0.844648531 | 1.21935371 | 2.59138595 | 0.805938034 |
| 1148 | 2.906236436 | 1.550674121 | 3.56959167 | 2.832126896 |
| 1149 | 2.837627443 | 3.707154326 | 4.53384262 | 2.625871865 |
| 1151 | 0.663392406 | 1.217197666 | 2.133352421 | 0.816460278 |

### Adjuncts

The cleaning compositions described herein may include other adjunct components. The cleaning compositions may comprise a surfactant system as described below. The cleaning composition may comprise a fabric shading agent as described below and/or an additional enzyme selected from lipases, amylases, proteases, mannanases, pectate lyases, cellulases, cutinases, and mixtures thereof. The cleaning composition may comprise a cleaning cellulase.

The composition may comprise a fabric shading agent. Suitable fabric shading agents include dyes, dye-clay conjugates, and pigments. Suitable dyes include small molecule dyes and polymeric dyes. Suitable small molecule dyes include small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof. Preferred dyes include alkoxylated azothiophenes, Solvent Violet 13, Acid Violet 50 and Direct Violet 9.

The cleaning compositions described herein may include one or more of the following non-limiting list of ingredients: fabric care benefit agent; detersive enzyme; deposition aid; rheology modifier; builder; chelant; bleach; bleaching agent; bleach precursor; bleach booster; bleach catalyst; perfume and/or perfume microcapsules; perfume loaded zeolite; starch encapsulated accord; polyglycerol esters; whitening agent; pearlescent agent; enzyme stabilizing systems; scavenging agents including fixing agents for anionic dyes, complexing agents for anionic surfactants, and mixtures thereof; optical brighteners or fluorescers; polymer including but not limited to soil release polymer and/or soil suspension polymer; dispersants; antifoam agents; non-aqueous solvent; fatty acid; suds suppressors, e.g., silicone suds suppressors; cationic starches; scum dispersants; substantive dyes; colorants; opacifier; antioxidant; hydrotropes such as toluenesulfonates, cumenesulfonates and naphthalenesulfonates; color speckles; colored beads, spheres or extrudates; clay softening agents; anti-bacterial agents. Additionally or alternatively, the compositions may comprise surfactants, quaternary ammonium compounds, and/or solvent systems. Quaternary ammonium compounds may be present in fabric enhancer compositions, such as fabric softeners, and comprise quaternary ammonium cations that are positively charged polyatomic ions of the structure NR₄⁺, where R is an alkyl group or an aryl group.

### Surfactant System

The cleaning composition may comprise a surfactant system. The cleaning composition may comprise from about 1% to about 80%, or from 1% to about 60%, preferably from about 5% to about 50% more preferably from about 8% to about 40%, by weight of the cleaning composition, of a surfactant system.

Surfactants of the present surfactant system may be derived from natural and/or renewable sources.

The surfactant system may comprise an anionic surfactant, more preferably an anionic surfactant selected from the group consisting of alkyl sulfate, alkyl alkoxy sulfate, especially alkyl ethoxy sulfate, alkyl benzene sulfonate, paraffin sulfonate and mixtures thereof. The surfactant system may further comprise a surfactant selected from the group consisting of nonionic surfactant, cationic surfactant, amphoteric surfactant, zwitterionic surfactant, and mixtures thereof. The surfactant system may comprise an amphoteric surfactant; the amphoteric surfactant may comprise an amine oxide surfactant. The surfactant system may comprise a nonionic surfactant; the nonionic surfactant may comprise an ethoxylated nonionic surfactant.

Alkyl sulfates are preferred for use herein and also alkyl ethoxy sulfates; more preferably a combination of alkyl sulfates and alkyl ethoxy sulfates with a combined average ethoxylation degree of less than 5, preferably less than 3, more preferably less than 2 and more than 0.5 and an average level of branching of from about 5% to about 40%.

The composition of the invention comprises amphoteric and/or zwitterionic surfactant, preferably the amphoteric surfactant comprises an amine oxide, preferably an alkyl dimethyl amine oxide, and the zwitteronic surfactant comprises a betaine surfactant.

The most preferred surfactant system for the detergent composition of the present invention comprise from 1% to 40%, preferably 6% to 35%, more preferably 8% to 30% weight of the total composition of an anionic surfactant, preferably an alkyl alkoxy sulfate surfactant, more preferably an alkyl ethoxy sulfate, combined with 0.5% to 15%, preferably from 1% to 12%, more preferably from 2% to 10% by weight of the composition of amphoteric and/or zwitterionic surfactant, more preferably an amphoteric and even more preferably an amine oxide surfactant, especially and alkyl dimethyl amine oxide. Preferably the composition further comprises a nonionic surfactant, especially an alcohol alkoxylate in particular and alcohol ethoxylate nonionic surfactant.

Anionic Surfactant

Anionic surfactants include, but are not limited to, those surface-active compounds that contain an organic hydrophobic group containing generally 8 to 22 carbon atoms or generally 8 to 18 carbon atoms in their molecular structure and at least one water-solubilizing group preferably selected from sulfonate, sulfate, and carboxylate so as to form a water-soluble compound. Usually, the hydrophobic group will comprise a C8-C 22 alkyl, or acyl group. Such surfactants are employed in the form of water-soluble salts and the salt-forming cation usually is selected from sodium, potassium, ammonium, magnesium and mono-, di- or tri-C2-C3 alkanolammonium, with the sodium cation being the usual one chosen.

The anionic surfactant can be a single surfactant but usually it is a mixture of anionic surfactants. Preferably the anionic surfactant comprises a sulfate surfactant, more preferably a sulfate surfactant selected from the group consisting of alkyl sulfate, alkyl alkoxy sulfate and mixtures thereof. Preferred alkyl alkoxy sulfates for use herein are alkyl ethoxy sulfates.

Sulfated Anionic Surfactant

Preferably the sulfated anionic surfactant is alkoxylated, more preferably, an alkoxylated branched sulfated anionic surfactant having an alkoxylation degree of from about 0.2 to about 4, even more preferably from about 0.3 to about 3, even more preferably from about 0.4 to about 1.5 and especially from about 0.4 to about 1. Preferably, the alkoxy group is ethoxy. When the sulfated anionic surfactant is a mixture of sulfated anionic surfactants, the alkoxylation degree is the weight average alkoxylation degree of all the components of the mixture (weight average alkoxylation degree). In the weight average alkoxylation degree calculation the weight of sulfated anionic surfactant components not having alkoxylated groups should also be included.

Weight average alkoxylation degree=(x1*alkoxylation degree of surfactant 1+x2*alkoxylation degree of surfactant 2+ . . . )/(x1+x2+ . . . )

wherein x1, x2, . . . are the weights in grams of each sulfated anionic surfactant of the mixture and alkoxylation degree is the number of alkoxy groups in each sulfated anionic surfactant.

Preferably, the branching group is an alkyl. Typically, the alkyl is selected from methyl, ethyl, propyl, butyl, pentyl, cyclic alkyl groups and mixtures thereof. Single or multiple alkyl branches could be present on the main hydrocarbyl chain of the starting alcohol(s) used to produce the sulfated anionic surfactant used in the detergent of the invention. Most preferably the branched sulfated anionic surfactant is selected from alkyl sulfates, alkyl ethoxy sulfates, and mixtures thereof.

The branched sulfated anionic surfactant can be a single anionic surfactant or a mixture of anionic surfactants. In the case of a single surfactant the percentage of branching refers to the weight percentage of the hydrocarbyl chains that are branched in the original alcohol from which the surfactant is derived.

In the case of a surfactant mixture the percentage of branching is the weight average and it is defined according to the following formula:

Weight average of branching (%)=[(x1*wt % branched alcohol 1 in alcohol 1+x2*wt % branched alcohol 2 in alcohol 2+ . . . )/(x1+x2+ . . . )]*100

wherein x1, x2, . . . are the weight in grams of each alcohol in the total alcohol mixture of the alcohols which were used as starting material for the anionic surfactant for the detergent of the invention. In the weight average branching degree calculation the weight of anionic surfactant components not having branched groups should also be included.

Suitable sulfate surfactants for use herein include water-soluble salts of C8-C18 alkyl or hydroxyalkyl, sulfate and/or ether sulfate. Suitable counterions include alkali metal cation or ammonium or substituted ammonium, but preferably sodium.

The sulfate surfactants may be selected from C8-C18 primary, branched chain and random alkyl sulfates (AS); C8-C18 secondary (2,3) alkyl sulfates; C8-C18 alkyl alkoxy sulfates (AExS) wherein preferably x is from 1-30 in which the alkoxy group could be selected from ethoxy, propoxy, butoxy or even higher alkoxy groups and mixtures thereof.

Alkyl sulfates and alkyl alkoxy sulfates are commercially available with a variety of chain lengths, ethoxylation and branching degrees. Commercially available sulfates include, those based on Neodol alcohols ex the Shell company, Lial-Isalchem and Safol ex the Sasol company, natural alcohols ex The Procter & Gamble Chemicals company.

Preferably, the anionic surfactant comprises at least 50%, more preferably at least 60% and especially at least 70% of a sulfate surfactant by weight of the anionic surfactant. Especially preferred detergents from a cleaning view point are those in which the anionic surfactant comprises more than 50%, more preferably at least 60% and especially at least 70% by weight thereof of sulfate surfactant and the sulfate surfactant is selected from the group consisting of alkyl sulfates, alkyl ethoxy sulfates and mixtures thereof. Even more preferred are those in which the anionic surfactant is an alkyl ethoxy sulfate with a degree of ethoxylation of from about 0.2 to about 3, more preferably from about 0.3 to about 2, even more preferably from about 0.4 to about 1.5, and especially from about 0.4 to about 1. They are also preferred anionic surfactant having a level of branching of from about 5% to about 40%, even more preferably from about 10% to 35% and especially from about 20% to 30%.

Sulfonate Surfactant

Suitable anionic sulfonate surfactants for use herein include water-soluble salts of C8-C18 alkyl or hydroxyalkyl sulfonates; C11-C18 alkyl benzene sulfonates (LAS), modified alkylbenzene sulfonate (MLAS) as discussed in WO 99/05243, WO 99/05242, WO 99/05244, WO 99/05082, WO 99/05084, WO 99/05241, WO 99/07656, WO 00/23549, and WO 00/23548; methyl ester sulfonate (MES); and alpha-olefin sulfonate (AOS). Those also include the paraffin sulfonates may be monosulfonates and/or disulfonates, obtained by sulfonating paraffins of 10 to 20 carbon atoms. The sulfonate surfactant also include the alkyl glyceryl sulfonate surfactants.

Nonionic Surfactant

Nonionic surfactant, when present, is comprised in a typical amount of from 0.1% to 40%, preferably 0.2% to 20%, most preferably 0.5% to 10% by weight of the composition. Suitable nonionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 18 carbon atoms, preferably from 10 to 15 carbon atoms with from 2 to 18 moles, preferably 2 to 15, more preferably 5-12 of ethylene oxide per mole of alcohol. Highly preferred nonionic surfactants are the condensation products of guerbet alcohols with from 2 to 18 moles, preferably 2 to 15, more preferably 5-12 of ethylene oxide per mole of alcohol.

Other suitable non-ionic surfactants for use herein include fatty alcohol polyglycol ethers, alkylpolyglucosides and fatty acid glucamides.

Amphoteric Surfactant

The surfactant system may include amphoteric surfactant, such as amine oxide. Preferred amine oxides are alkyl dimethyl amine oxide or alkyl amido propyl dimethyl amine oxide, more preferably alkyl dimethyl amine oxide and especially coco dimethyl amino oxide Amine oxide may have a linear or mid-branched alkyl moiety. Typical linear amine oxides include water-soluble amine oxides containing one R1 C8-18 alkyl moiety and 2 R2 and R3 moieties selected from the group consisting of C1-3 alkyl groups and C1-3 hydroxyalkyl groups. Preferably amine oxide is characterized by the formula R1-N(R2)(R3) 0 wherein R1 is a C8-18 alkyl and R2 and R3 are selected from the group consisting of methyl, ethyl, propyl, isopropyl, 2-hydroxethyl, 2-hydroxypropyl and 3-hydroxypropyl. The linear amine oxide surfactants in particular may include linear C10-C18 alkyl dimethyl amine oxides and linear C8-C12 alkoxy ethyl dihydroxy ethyl amine oxides. Preferred amine oxides include linear C10, linear C10-C12, and linear C12-C14 alkyl dimethyl amine oxides. As used herein “mid-branched” means that the amine oxide has one alkyl moiety having n1 carbon atoms with one alkyl branch on the alkyl moiety having n2 carbon atoms. The alkyl branch is located on the a carbon from the nitrogen on the alkyl moiety. This type of branching for the amine oxide is also known in the art as an internal amine oxide. The total sum of n1 and n2 is from 10 to 24 carbon atoms, preferably from 12 to 20, and more preferably from 10 to 16. The number of carbon atoms for the one alkyl moiety (n1) should be approximately the same number of carbon atoms as the one alkyl branch (n2) such that the one alkyl moiety and the one alkyl branch are symmetric. As used herein “symmetric” means that |n1−n2| is less than or equal to 5, preferably 4, most preferably from 0 to 4 carbon atoms in at least 50 wt %, more preferably at least 75 wt % to 100 wt % of the mid-branched amine oxides for use herein.

The amine oxide further comprises two moieties, independently selected from a C1-3 alkyl, a C1-3 hydroxyalkyl group, or a polyethylene oxide group containing an average of from about 1 to about 3 ethylene oxide groups. Preferably the two moieties are selected from a C1-3 alkyl, more preferably both are selected as a C1 alkyl.

Zwitterionic Surfactant

Other suitable surfactants include betaines, such as alkyl betaines, alkylamidobetaine, amidazoliniumbetaine, sulfobetaine (INCI Sultaines) as well as the Phosphobetaine and preferably meets formula (I):

R¹—[CO—X(CH₂)ₙ]ₓ—N⁺(R²)(R₃)—(CH₂)ₘ—[CH(OH)—CH₂]_{y}—Y— (I)
wherein
R¹ is a saturated or unsaturated C6-22 alkyl residue, preferably C8-18 alkyl residue, in particular a saturated C10-16 alkyl residue, for example a saturated C12-14 alkyl residue;
X is NH, NR⁴ with C1-4 Alkyl residue R⁴, O or S,
n a number from 1 to 10, preferably 2 to 5, in particular 3,
x 0 or 1, preferably 1,
R², R³ are independently a C1-4 alkyl residue, potentially hydroxy substituted such as a hydroxyethyl, preferably a methyl.
m a number from 1 to 4, in particular 1, 2 or 3,
y 0 or 1 and
Y is COO, SO3, OPO(OR⁵)O or P(O)(OR⁵)O, whereby R⁵ is a hydrogen atom H or a C1-4 alkyl residue.

Preferred betaines are the alkyl betaines of the formula (Ia), the alkyl amido propyl betaine of the formula (Ib), the Sulfo betaines of the formula (Ic) and the Amido sulfobetaine of the formula (Id);

R¹—N⁺(CH₃)₂—CH₂COO⁻ (Ia)

R¹—CO—NH(CH₂)₃—N⁺(CH₃)₂—CH₂COO⁻ (Ib)

R¹—N⁺(CH₃)₂—CH₂CH(OH)CH₂SO₃— (Ic)

R¹—CO—NH—(CH₂)₃—N⁺(CH₃)₂—CH₂CH(OH)CH₂SO₃— (Id)

in which R¹ has the same meaning as in formula I. Particularly preferred betaines are the Carbobetaine [wherein Y⁻═COO⁻], in particular the Carbobetaine of the formula (Ia) and (Ib), more preferred are the Alkylamidobetaine of the formula (Ib).

Examples of suitable betaines and sulfobetaine are the following [designated in accordance with INCI]: Almondamidopropyl of betaines, Apricotam idopropyl betaines, Avocadamidopropyl of betaines, Babassuamidopropyl of betaines, Behenam idopropyl betaines, Behenyl of betaines, betaines, Canolam idopropyl betaines, Capryl/Capram idopropyl betaines, Carnitine, Cetyl of betaines, Cocamidoethyl of betaines, Cocam idopropyl betaines, Cocam idopropyl Hydroxysultaine, Coco betaines, Coco Hydroxysultaine, Coco/Oleam idopropyl betaines, Coco Sultaine, Decyl of betaines, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl of PG-betaines, Erucam idopropyl Hydroxysultaine, Hydrogenated Tallow of betaines, Isostearam idopropyl betaines, Lauram idopropyl betaines, Lauryl of betaines, Lauryl Hydroxysultaine, Lauryl Sultaine, Milkam idopropyl betaines, Minkamidopropyl of betaines, Myristam idopropyl betaines, Myristyl of betaines, Oleam idopropyl betaines, Oleam idopropyl Hydroxysultaine, Oleyl of betaines, Olivamidopropyl of betaines, Palmam idopropyl betaines, Palm itam idopropyl betaines, Palmitoyl Carnitine, Palm Kernelam idopropyl betaines, Polytetrafluoroethylene Acetoxypropyl of betaines, Ricinoleam idopropyl betaines, Sesam idopropyl betaines, Soyam idopropyl betaines, Stearam idopropyl betaines, Stearyl of betaines, Tallowam idopropyl betaines, Tallowam idopropyl Hydroxysultaine, Tallow of betaines, Tallow Dihydroxyethyl of betaines, Undecylenam idopropyl betaines and Wheat Germam idopropyl betaines.

A preferred betaine is, for example, Cocoamidopropylbetaine.

### Methods of Making the Composition

The present disclosure relates to methods of making the compositions described herein. The compositions of the invention may be solid (for example granules or tablets) or liquid form. Preferably the compositions are in liquid form. They may be made by any process chosen by the formulator, including by a batch process, a continuous loop process, or combinations thereof.

When in the form of a liquid, the compositions of the invention may be aqueous (typically above 2 wt % or even above 5 or 10 wt % total water, up to 90 or up to 80 wt % or 70 wt % total water) or non-aqueous (typically below 2 wt % total water content). Typically the compositions of the invention will be in the form of an aqueous solution or uniform dispersion or suspension of optical brightener, DTI and optional additional adjunct materials, some of which may normally be in solid form, that have been combined with the normally liquid components of the composition, such as the liquid alcohol ethoxylate nonionic, the aqueous liquid carrier, and any other normally liquid optional ingredients. Such a solution, dispersion or suspension will be acceptably phase stable. When in the form of a liquid, the detergents of the invention preferably have viscosity from 1 to 1500 centipoises (1-1500 mPa*s), more preferably from 100 to 1000 centipoises (100-1000 mPa*s), and most preferably from 200 to 500 centipoises (200-500 mPa*s) at 20s-1 and 21° C. Viscosity can be determined by conventional methods. Viscosity may be measured using an AR 550 rheometer from TA instruments using a plate steel spindle at 40 mm diameter and a gap size of 500 μm. The high shear viscosity at 20s-1 and low shear viscosity at 0.05-1 can be obtained from a logarithmic shear rate sweep from 0.1-1 to 25-1 in 3 minutes time at 21 C. The preferred rheology described therein may be achieved using internal existing structuring with detergent ingredients or by employing an external rheology modifier. More preferably the detergents, such as detergent liquid compositions have a high shear rate viscosity of from about 100 centipoise to 1500 centipoise, more preferably from 100 to 1000 cps. Unit Dose detergents, such as detergent liquid compositions have high shear rate viscosity of from 400 to 1000 cps. Detergents such as laundry softening compositions typically have high shear rate viscosity of from 10 to 1000, more preferably from 10 to 800 cps, most preferably from 10 to 500 cps. Hand dishwashing compositions have high shear rate viscosity of from 300 to 4000 cps, more preferably 300 to 1000 cps.

The cleaning and/or treatment compositions in the form of a liquid herein can be prepared by combining the components thereof in any convenient order and by mixing, e.g., agitating, the resulting component combination to form a phase stable liquid detergent composition. In a process for preparing such compositions, a liquid matrix is formed containing at least a major proportion, or even substantially all, of the liquid components, e.g., nonionic surfactant, the non-surface active liquid carriers and other optional liquid components, with the liquid components being thoroughly admixed by imparting shear agitation to this liquid combination. For example, rapid stirring with a mechanical stirrer may usefully be employed. While shear agitation is maintained, substantially all of any anionic surfactants and the solid form ingredients can be added. Agitation of the mixture is continued, and if necessary, can be increased at this point to form a solution or a uniform dispersion of insoluble solid phase particulates within the liquid phase. After some or all of the solid-form materials have been added to this agitated mixture, particles of any enzyme material to be included, e.g., enzyme granulates, are incorporated. As a variation of the composition preparation procedure hereinbefore described, one or more of the solid components may be added to the agitated mixture as a solution or slurry of particles premixed with a minor portion of one or more of the liquid components. After addition of all of the composition components, agitation of the mixture is continued for a period of time sufficient to form compositions having the requisite viscosity and phase stability characteristics. Frequently this will involve agitation for a period of from about 30 to 60 minutes.

The adjunct ingredients in the compositions of this invention may be incorporated into the composition as the product of the synthesis generating such components, either with or without an intermediate purification step. Where there is no purification step, commonly the mixture used will comprise the desired component or mixtures thereof (and percentages given herein relate to the weight percent of the component itself unless otherwise specified) and in addition unreacted starting materials and impurities formed from side reactions and/or incomplete reaction. For example, for an ethoxylated or substituted component, the mixture will likely comprise different degrees of ethoxylation/substitution.

### Method of Use

The present disclosure relates to methods of using the cleaning compositions of the present disclosure to clean a surface, such as a textile. In general, the method includes mixing the cleaning composition as described herein with water to form an aqueous liquor and contacting a surface, preferably a textile, with the aqueous liquor in a laundering step. The target surface may include a greasy soil.

The compositions of this invention, typically prepared as hereinbefore described, can be used to form aqueous washing/treatment solutions for use in the laundering/treatment of fabrics and/or hard surfaces. Generally, an effective amount of such a composition is added to water, for example in a conventional fabric automatic washing machine, to form such aqueous laundering solutions. The aqueous washing solution so formed is then contacted, typically under agitation, with the fabrics to be laundered/treated therewith. An effective amount of the detergent composition herein added to water to form aqueous laundering solutions can comprise amounts sufficient to form from about 500 to 25,000 ppm, or from 500 to 15,000 ppm of composition in aqueous washing solution, or from about 1,000 to 3,000 ppm of the detergent compositions herein will be provided in aqueous washing solution.

Typically, the wash liquor is formed by contacting the detergent with wash water in such an amount so that the concentration of the detergent in the wash liquor is from above 0 g/l to 5 g/l, or from 1 g/l, and to 4.5 g/l, or to 4.0 g/l, or to 3.5 g/l, or to 3.0 g/l, or to 2.5 g/l, or even to 2.0 g/l, or even to 1.5 g/l. The method of laundering fabric or textile may be carried out in a top-loading or front-loading automatic washing machine, or can be used in a hand-wash laundry application. In these applications, the wash liquor formed and concentration of laundry detergent composition in the wash liquor is that of the main wash cycle. Any input of water during any optional rinsing step(s) is not included when determining the volume of the wash liquor.

The wash liquor may comprise 40 litres or less of water, or 30 litres or less, or 20 litres or less, or 10 litres or less, or 8 litres or less, or even 6 litres or less of water. The wash liquor may comprise from above 0 to 15 litres, or from 2 litres, and to 12 litres, or even to 8 litres of water. Typically from 0.01 kg to 2 kg of fabric per litre of wash liquor is dosed into said wash liquor. Typically from 0.01 kg, or from 0.05 kg, or from 0.07 kg, or from 0.10 kg, or from 0.15 kg, or from 0.20 kg, or from 0.25 kg fabric per litre of wash liquor is dosed into said wash liquor. Optionally, 50 g or less, or 45 g or less, or 40 g or less, or 35 g or less, or 30 g or less, or 25 g or less, or 20 g or less, or even 15 g or less, or even 10 g or less of the composition is contacted to water to form the wash liquor. Such compositions are typically employed at concentrations of from about 500 ppm to about 15,000 ppm in solution. When the wash solvent is water, the water temperature typically ranges from about 5° C. to about 90° C. and, when the situs comprises a fabric, the water to fabric ratio is typically from about 1:1 to about 30:1. Typically the wash liquor comprising the detergent of the invention has a pH of from 3 to 11.5.

In one aspect, such method comprises the steps of optionally washing and/or rinsing said surface or fabric, contacting said surface or fabric with any composition disclosed in this specification then optionally washing and/or rinsing said surface or fabric is disclosed, with an optional drying step.

Drying of such surfaces or fabrics may be accomplished by any one of the common means employed either in domestic or industrial settings: machine drying or open-air drying. The fabric may comprise any fabric capable of being laundered in normal consumer or institutional use conditions, and the invention is particularly suitable for synthetic textiles such as polyester and nylon and especially for treatment of mixed fabrics and/or fibres comprising synthetic and cellulosic fabrics and/or fibres. As examples of synthetic fabrics are polyester, nylon, these may be present in mixtures with cellulosic fibres, for example, polycotton fabrics. The solution typically has a pH of from 7 to 11, more usually 8 to 10.5. The compositions are typically employed at concentrations from 500 ppm to 5,000 ppm in solution. The water temperatures typically range from about 5° C. to about 90° C. The water to fabric ratio is typically from about 1:1 to about 30:1.

### Use of Malodor Reduction Materials

The present disclosure further relates to a use of malodor reduction materials in a cleaning composition to enhance the malodor-reducing benefits of a nuclease enzyme.

### COMBINATIONS

Specifically contemplated combinations of the disclosure are herein described in the following numbered paragraphs. These combinations are intended to be illustrative in nature and are not intended to be limiting.

A. A cleaning composition comprising a nuclease enzyme and one or more malodor reduction materials.

B. A cleaning composition according to paragraph A, wherein the nuclease enzyme is a deoxyribonuclease enzyme, a ribonuclease enzyme, or a mixture thereof.

C. A cleaning composition according to any of paragraphs A-B, wherein the nuclease enzyme is selected from any of E.C. classes E.C. 3.1.21.x (where x=1, 2, 3, 4, 5, 6, 7, 8, 9), 3.1.22.y (where y=1, 2, 4, 5), E.C. 3.1.30.z (where z=1, 2) or E.C. 3.1.31.1, or mixtures thereof, preferably from E.C. 3.1.21, preferably E.C. 3.1.21.1.

D. A cleaning composition according to any of paragraphs A-C, wherein the nuclease enzyme comprises a deoxyribonuclease enzyme.

E. A cleaning composition according to any of paragraphs A-D, where the enzyme comprises an enzyme having both RNase and DNase activity, preferably being from E.C. 3.1.30.2.

F. A cleaning composition according to any of paragraphs A-E, wherein the nuclease enzyme is a microbial enzyme, preferably a bacterial enzyme.

G. A cleaning composition according to any of paragraphs A-F, wherein the enzyme has an amino acid sequence having at least 85%, or at least 90 or at least 95% or even 100% identity with the amino acid sequence shown in SEQ ID NO:1, SEQ ID NO:2 or SEQ ID NO:3.

H. A cleaning composition according to any of paragraphs A-G, wherein the composition further comprises a β-N-acetylglucosaminidase enzyme from E.C. 3.2.1.52, preferably an enzyme having at least 70% identity to SEQ ID NO:4.

I. A cleaning composition according to any of paragraphs A-H, wherein the cleaning composition comprises a sum total of from about 0.00025% to about 0.5%, by weight of the cleaning composition, of one or more malodor reduction materials.

J. A cleaning composition according to any of paragraphs A-I, wherein said one or more malodor reduction material has a MORV of at least 0.5, preferably from 0.5 to 10, more preferably from 1 to 10, most preferably from 1 to 5, as determined by the test methods described herein.

K. A cleaning composition according to any of paragraphs A-J, wherein the cleaning composition comprises at least one, preferably all, of the one or more malodor reduction materials has a Universal MORV.

L. A cleaning composition according to any of paragraphs A-K, wherein the sum total of the one or more malodor reduction materials in the cleaning composition has a Blocker Index of less than 3, more preferable less than about 2.5, even more preferably less than about 2, and still more preferably less than about 1, and most preferably about 0.

M. A cleaning composition according to any of paragraphs A-L, wherein the one or more malodor reduction material has a Fragrance Fidelity Index of less than 3, preferably less than 2, more preferably less than 1, and most preferably about 0.

N. A cleaning composition according to any of paragraphs A-M, wherein one or more malodor reduction materials has a log P greater than about 3, preferably greater than about 3 but less than about 8.

O. A cleaning composition according to any of paragraphs A-N, wherein one or more malodor reduction materials has a vapor pressure of greater than about 0.01 torr, preferably greater than about 0.01 torr to about 10 torr.

P. A cleaning composition according to any of paragraphs A-O, wherein the one or more malodor reduction materials is selected from the group consisting of: 2,4-dimethyl-2-(5,5,8,8-tetramethyl-5,6,7,8-tetrahydronaphthalen-2-yl)-1,3-dioxolane; 3-methoxy-7,7-dimethyl-10-methylenebicyclo[4.3.1]decane; Oxybenzone; Oxyoctaline formate; 3a,5,6,7,8,8b-hexahydro-2,2,6,6,7,8,8-heptamethyl-4H-indeno(4,5-d)-1,3-dioxole; 3a,5,6,7,8,8b-hexahydro-2,2,6,6,7,8,8-heptamethyl-4H-indeno(4,5-d)-1,3-dioxole; 2,2,6,8-tetramethyl-1,2,3,4,4a,5,8,8a-octahydronaphthalen-1-ol; Nootkatone; 1-ethyl-3-methoxytricyclo[2.2.1.02,6]heptane; 10-isopropyl-2,7-dimethyl-1-oxaspiro[4.5]deca-3,6-diene; Methyl stearate; Methyl linoleate; Methyl isoeugenol; Methyl eugenol; 2,4-dimethyl-4,4a,5,9b-tetrahydroindeno[1,2-d][1,3]dioxine; 4-(4-hydroxy-4-methylpentyl)cyclohex-3-ene-1-carbaldehyde; (Z)-3-hexen-1-yl-2-cyclopenten-1-one; (2,5-dimethyl-1,3-dihydroinden-2-yl)methanol; Khusimol; (1-methyl-24-(1,2,2-trimethylbicyclo[3.1.0]hexan-3-yl)methyl)cyclopropyl)methanol; 2,6,9,10-tetramethyl-1-oxaspiro(4.5)deca-3,6-diene; Isopropyl palmitate; Isopimpinellin; Iso3-methylcyclopentadecan-1-one; Isoeugenyl benzyl ether; 1-((2S,3S)-2,3,8,8-tetramethyl-1,2,3,4,5,6,7,8-octahydronaphthalen-2-yl)ethan-1-one; Isobornylcyclohexanol; Isobornyl propionate; Isobornyl isobutyrate; Isobornyl cyclohexanol; Isobergamate; Hydroxymethyl isolongifolene; 2,3-dihydro-3,3-dimethyl-1H-indene-5-propanal; 3-(3,3-dimethyl-2,3-dihydro-1H-inden-5-yl)propanal; 3a,4,5,6,7,7a-hexahydro-1H-4,7-methanoinden-6-yl acetate; Guaiol; gamma-Muurolene; gamma-Himachalene; gamma-Eudesmol; gamma-Cadinene; 4,6,6,7,8,8-hexamethyl-1,3,4,6,7,8-hexahydrocyclopenta[g]isochromene; 8,8-dimethyl-3a,4,5,6,7,7a-hexahydro-1H-4,7-methanoinden-6-yl propionate; (Z)-6-ethylideneoctahydro-2H-5,8-methanochromen-2-one; (E)-4-((3aR,4R,7R,7aR)-1,3a,4,6,7,7a-hexahydro-5H-4,7-methanoinden-5-ylidene)-3-methylbutan-2-ol; 8,8-dimethyl-3a,4,5,6,7,7a-hexahydro-1H-4,7-methanoinden-6-yl acetate; 3-(4-ethylphenyl)-2,2-dimethylpropanenitrile; 1-cyclopentadec-4-en-1-one; 1-cyclopentadec-4-en-1-one; Eugenyl acetate; 6-ethyl-2,10,10-trimethyl-1-oxaspiro[4.5]deca-3,6-diene; (E)-4-((3aS,7aS)-octahydro-5H-4,7-methanoinden-5-ylidene)butanal; Octahydro-1H-4,7-methanoinden-5-yl acetate; delta-Cadinene; delta-Amorphene; Decyl anthranilate; 3a,4,5,6,7,7a-hexahydro-1H-4,7-methanoinden-6-yl butyrate; 3a,4,5,6,7,7a-hexahydro-1H-4,7-methanoinden-5-ylisobutyrate; Curzerene; (E)-cycloheptadec-9-en-1-one; (Z)-3-methyl-2-(pent-2-en-1-yl)cyclopent-2-en-1-one; (E)-1-(2,6,6-trimethylcyclohex-2-en-1-yl)hepta-1,6-dien-3-one; (3aR,5aR,9aR,9bR)-3a,6,6,9a-tetramethyldodecahydronaphtho[2,1-b]furan; Cedryl methyl ether; Cedryl formate; Cedryl acetate; (4Z,8Z)-1,5,9-trimethyl-13-oxabicyclo[10.1.0]trideca-4,8-diene; Cedrol; 5-methyl-1-(2,2,3-trimethylcyclopent-3-en-1-yl)-6-oxabicyclo[3.2.1]octane; 1,1,2,3,3-pentamethyl-1,2,3,5,6,7-hexahydro-4H-inden-4-one; Caryophyllene alcohol acetate; Caryolan-1-ol; Bornyl isobutyrate; beta-Santalol; beta-Patchoulline; beta-Himachalene Oxide; beta-Himachalene; beta-Guaiene; (2,2-dimethoxyethyl)benzene; beta-Copaene; beta-Cedrene; beta-Caryophyllene; Bergaptene; Benzyl laurate; 2′-isopropyl-1,7,7-trimethylspiro[bicyclo[2.2.1]heptane-2,4′-[1,3]clioxane]; Anisyl phenylacetate; (3aR,5aS,9aS,9bR)-3a,6,6,9a-tetramethyldodecahydronaphtho[2,1-b]furan; (4aR,5R,7aS,9R)-2,2,5,8,8,9a-hexamethyloctahydro-4H-4a,9-methanoazuleno[5,6-d][1,3]dioxole; 2,5,5-trimethyl-1,2,3,4,5,6,7,8-octahydronaphthalen-2-ol; (3S,5aR,7aS,11aS,1 lbR)-3,8,8,11a-tetramethyldodecahydro-5H-3,5a-epoxynaphtho[2,1-c]oxepine; 2,2,6,6,7,8,8-heptamethyldecahydro-2H-indeno[4,5-b]furan; alpha-Vetivone; alpha-Santalol; alpha-Patchoulene; alpha-Muurolene; alpha-methyl ionone; alpha-Gurjunene; alpha-Eudesmol; alpha-Cubebene; alpha-Cedrene epoxide; alpha-Cadinol; alpha-Cadinene; alpha-Bisabolol; alpha-Amorphene; alpha-Agarofuran; Allo-aromadendrene; Acetoxymethyl-isolongifolene (isomers); Acetarolle; (Z)-2-(4-methylbenzylidene)heptanal; 7-eip-alpha-Eudesmol; 7-Acetyl-1,1,3,4,4,6-hexamethyltetralin; 5-Cyclohexadecenone; 4-(p-Methoxyphenyl)-2-butanone; 3-Thujopsanone; 2,6-Nonadien-1-ol; 10-epi-gamma-Eudesmol; 1,1,2,3,3-Pentamethylindan; (2S,5S,6S)-2,6,10,10-tetramethyl-1-oxaspiro[4_5]decan-6-ol; 2-(8-isopropyl-6-methylbicyclo[2.2.2]oct-5-en-2-yl)-1,3-dioxolane; 3a,4,5,6,7,7a-hexahydro-1H-4,7-methanoinden-6-yl propionate; Bulnesol; Benzoin; 5-Acetyl-1,1,2,3,3,6-hexamethylindan; Patchouli alcohol; Perillyl alcohol; Phenethyl phenylacetate; Phenoxanol; 3a,4,5,6,7,7a-hexahydro-1H-4,7-methanoinden-6-yl pivalate; p-Tolyl phenylacetate; (2R,4a′R,8a′R)-3,7′-dimethyl-3′,4′,4a′,5′,8′,8a′-hexahydro-1′H-spiro[oxirane-2,2′-[1,4]methanonaphthalene]; (Z)-6-ethylideneoctahydro-2H-5,8-methanochromene; 2,2,7,9-tetramethylspiro(5.5)undec-8-en-1-one; 3-methyl-5-(2,2,3-trimethylcyclopent-3-en-1-yl)pentan-2-ol; (Z)-2-ethyl-4-(2,2,3-trimethylcyclopent-3-en-1-yl)but-2-en-1-ol; 5-methoxyoctahydro-1H-4,7-methanoindene-2-carbaldehyde; Sclareol; Sclareol oxide; Selina-3,7(11)-diene; Spathulenol; 1-(spiro[4.5]dec-7-en-7-yl)pent-4-en-1-one; tau-Cadinol; tau-Muurolol; Thujopsene; 1-(2,2,6-trimethylcyclohexyl)hexan-3-ol; Tricyclone; Methyl 2-((1-hydroxy-3-phenylbutyl)amino)benzoate; Decahydro-2,6,6,7,8,8-hexamethyl-2h-indeno(4,5-b)furan; Valencene; Valerianol; 1-methoxy-3a,4,5,6,7,7a-hexahydro-1H-4,7-methanoindene; 1-((3R,3aR,7R,8aS)-3,6,8,8-tetramethyl-2,3,4,7,8,8a-hexahydro-1H-3a,7-methanoazulen-5-yl)ethan-1-one; Methyl (Z)-2-(((2,4-dimethylcyclohex-3-en-1-yl)methylene)amino)benzoate; Vetiverol; Vetivert Acetate; Decahydro-3H-spiro[furan-2,5′-[4,7]methanoindene]; (Z)-cyclooct-4-en-1-yl methyl carbonate; (1aR,4S,4aS,7R,7aS,7bS)-1,1,4,7-tetramethyldecahydro-1H-cyclopropa[e]azulen-4-ol; 3,5,5,6,7,8,8-heptamethyl-5,6,7,8-tetrahydronaphthalene-2-carbonitrile; (1S,2S,3S,5R)-2,6,6-trimethylspiro[bicyclo[3.1.1]heptane-3,1′-cyclohexan]-2′-en-4′-one; 1′,1′,5′,5′-tetramethylhexahydro-2′H,5′H-spiro[[1,3]dioxolane-2,8′-[2,4a]methanonaphthalene]; 1′,1′,5′,5′-tetramethylhexahydro-2′H,5′H-spiro[[1,3]dioxolane-2,8′-[2,4a]methanonaphthalene] K; 4-(4-hydroxy-3-methoxyphenyl)butan-2-one; (1R,8aR)-4-isopropyl-1,6-dimethyl-1,2,3,7,8,8a-hexahydronaphthalene; 4,5-epoxy-4,11,11-trimethyl-8-methylenebicyclo(7.2.0)undecane; 1,3,4,6,7,8alpha-hexahydro-1,1,5,5-tetramethyl-2H-2,4alpha-methanophtalen-8(5H)-one; 1-(2,2-dimethyl-6-methylen cyclohexyl)-1-penten-3-one; and combinations thereof.

Q. A cleaning composition according to any of paragraphs A-P, wherein the one or more malodor reduction materials is selected from the group consisting of: 3-(3,3-dimethyl-2,3-dihydro-1H-inden-5-yl)propanal; 3-(6,6-dimethylbicyclo[3.1.1]hept-2-en-2-yl)-2,2-dimethylpropanal; 3-methyl-5-phenylpentan-1-ol; E)-3,7-dimethylocta-2,6-dien-1-yl palmitate; 3a,4,5,6,7,7a-hexahydro-4,7-methano-1H-inden-(5 and 6)-yl acetate; 3,4,4a,5,6,7,8,8a-octahydrochromen-2-one; 2,2,7,7-tetramethyltricyclo(6.2.1.0(1,6))-undecan-5-one; (E)-3,7-dimethylocta-1,3,6-triene; 1-((2-(tert-butyl)cyclohexyl)oxy)butan-2-ol; and combinations thereof.

R. A cleaning composition according to any of paragraphs A-Q, wherein cleaning composition further comprises a perfume.

S. A cleaning composition according to any of paragraphs A-R, wherein the weight ratio of parts of malodor reduction composition to parts of perfume may be from about 1:20,000 to about 3000:1, preferably from about 1:10,000 to about 1,000:1, more preferably from about 5,000:1 to about 500:1, and most preferably from about 1:15 to about 1:1.

T. A cleaning composition according to any of paragraphs A-S, wherein the cleaning composition further comprises from about 1% to about 80%, by weight of the cleaning composition, of a surfactant system.

U. A cleaning composition according to any of paragraphs A-T, wherein the surfactant system comprises an anionic surfactant, preferably selected from the group consisting of alkyl sulfate, alkyl alkoxy sulfate, alkyl benzene sulfonate, paraffin sulfonate, and mixtures thereof.

V. A method of cleaning a surface, preferably a textile, comprising mixing the cleaning composition according to any of paragraphs A-U with water to form an aqueous liquor and contacting a surface, preferably a textile, with the aqueous liquor in a laundering step.

W. The use of one or more malodor reducing materials in a cleaning composition to enhance the malodor-reducing benefits of a nuclease enzyme.

### TEST METHODS

### Viscosity Test Method

Viscosity is measured using an AR 550 rheometer/viscometer from TA instruments (New Castle, Del., USA), using parallel steel plates of 40 mm diameter and a gap size of 500 μm. The high shear viscosity at 20 s₋₁ is obtained from a logarithmic shear rate sweep from 0.1 s₋₁ to 25 s₋₁ in 3 minutes time at 21° C.

### Test Method for Determining Saturation Vapour Pressure (VP)

The saturation Vapour Pressure (VP) values are computed for each PRM in the perfume mixture being tested. The VP of an individual PRM is calculated using the VP Computational Model, version 14.02 (Linux) available from Advanced Chemistry Development Inc. (ACD/Labs) (Toronto, Canada) to provide the VP value at 25° C. expressed in units of torr. The ACD/Labs' Vapor Pressure model is part of the ACD/Labs model suite.

Test Method for Determining the Logarithm of the Octanol/Water Partition Coefficient (logP)

The value of the log of the Octanol/Water Partition Coefficient (logP) is computed for each PRM in the perfume mixture being tested. The logP of an individual PRM is calculated using the Consensus logP Computational Model, version 14.02 (Linux) available from Advanced Chemistry Development Inc. (ACD/Labs) (Toronto, Canada) to provide the unitless logP value. The ACD/Labs' Consensus logP Computational Model is part of the ACD/Labs model suite.

### Test Method for the Generation of Molecular Descriptors

In order to conduct the calculations involved in the computed-value test methods described herein, the starting information required includes the identity, weight percent, and molar percent of each PRM in the perfume being tested, as a proportion of that perfume, wherein all PRMs in the perfume composition are included in the calculations. Additionally for each of those PRMs, the molecular structure, and the values of various computationally-derived molecular descriptors are also required, as determined in accordance with the Test Method for the Generation of Molecular Descriptors described herein.

For each PRM in a perfume mixture or composition, its molecular structure is used to compute various molecular descriptors. The molecular structure is determined by the graphic molecular structure representations provided by the Chemical Abstract Service (“CAS”), a division of the American Chemical Society, Columbus, Ohio, U.S.A. These molecular structures may be obtained from the CAS Chemical Registry System database 10 by looking up the index name or CAS number of each PRM. For PRMs, which at the time of their testing are not yet listed in the CAS Chemical Registry System database, other databases or information sources may be used to determine their structures. For a PRM which has potentially more than one isomer present, the molecular descriptor computations are conducted using the molecular structure of only one of the isomers, which is selected to represent that PRM. The selection of isomer is determined by the relative amount of extension in the molecular structures of the isomers. Of all the isomers of a given PRM, it is the isomer whose molecular structure that is the most prevalent which is the one that is selected to represent that PRM. The structures for other potential isomers of that PRM are excluded from the computations. The molecular structure of the isomer that is the most prevalent is paired with the concentration of that PRM, where the concentration reflects the presence of all the isomers of that PRM that are present.

A molecule editor or molecular sketching software program, such as ChemDraw (CambridgeSoft/PerkinElmer Inc., Waltham, Mass., U.S.A.), is used to duplicate the 2-dimensional molecular structure representing each PRM. Molecular structures should be represented as neutral species (quaternary nitrogen atoms are allowed) with no disconnected fragments (e.g., single structures with no counter ions). The winMolconn program described below can convert any deprotonated functional groups to the neutral form by adding the appropriate number of hydrogen atoms and will discard the counter ion.

For each PRM, the molecular sketching software is used to generate a file which describes the molecular structure of the PRM. The file(s) describing the molecular structures of the PRMs is subsequently submitted to the computer software program winMolconn, version 1.0.1.3 (Hall Associates Consulting, Quincy, Mass., U.S.A., www.molconn.com), in order to derive various molecular descriptors for each PRM. As such, it is the winMolconn software program which dictates the structure notations and file formats that are acceptable options. These options include either a MACCS SDF formatted file (i.e., a Structure-Data File); or a Simplified Molecular Input Line Entry Specification (i.e., a SMILES string structure line notation) which is commonly used within a simple text file, often with a “.smi” or “.txt” file name extension. The SDF file represents each molecular structure in the 5 format of a multi-line record, while the syntax for a SMILES structure is a single line of text with no white space. A structure name or identifier can be added to the SMILES string by including it on the same line following the SMILES string and separated by a space, e.g.: C1=CC═CC═C1 benzene.

The winMolconn software program is used to generate numerous molecular descriptors for each PRM, which are then output in a table format. Specific molecular descriptors derived by winMolconn are subsequently used as inputs (i.e., as variable terms in mathematical equations) for a variety of computer model test methods in order to calculate values such as: saturation Vapour Pressure (VP); Boiling Point (BP); logarithm of the Octanol/Water Partition Coefficient (logP); Odour Detection Threshold (ODT); Malodour Reduction Value (MORV); and/or Universal Malodour Reduction Value (Universal MORV) for each PRM. The molecular descriptor labels used in the models' test method computations are the same labels reported by the winMolconn program, and their descriptions and definitions can be found listed in the winMolconn documentation. The following is a generic description of how to execute the winMolconn software program and generate the required molecular structure descriptors for each PRM in a composition.

Computing Molecular Structure Descriptors using winMolconn:
1) Assemble the molecular structure for one or more perfume ingredients in the form of a MACCS Structure-Data File, also called an SDF file, or as a SMILES file.
2) Using version 1.0.1.3 of the winMolconn program, running on an appropriate computer, compute the full complement of molecular descriptors that are available from the program, using the SDF or SMILES file described above as input.
   a. The output of winMolconn is in the form of an ASCII text file, typically space delimited, containing the structure identifiers in the first column and respective molecular descriptors in the remaining columns for each structure in the input file.
3) Parse the text file into columns using a spreadsheet software program or some other appropriate technique. The molecular descriptor labels are found on the first row of the resulting table.
4) Find and extract the descriptor columns, identified by the molecular descriptor label, corresponding to the inputs required for each model.
   a. Note that the winMolconn molecular descriptor labels are case-sensitive.

### MORV and Universal MORV Calculation

1.) Input Molecular Descriptor values as determined via the method above into the following four equations:

MORV=−8.5096+2.8597·(dxp9)+1.1253·(knotpv)−0.34484·(e1C2O2)−10 0.00046231·(idw)+3.3509·(idcbar)+0.11158·(n2pag22) a)

MORV=−5.2917+2.1741·(dxvp5)−2.6595−(dxvp8)+0.45297·(e1C2C2d)−0.6202·(c1C2O2)+1.3542−(CdCH2)+0.68105·(CaasC)+1.7129·(idcbar) b)

MORV=−0.0035+0.8028·(SHCsatu)+2.1673·(xvp7)−1.3507−(c1C1C3d)+0.61496·(c1C1O2)+0.00403·(idc)−0.23286·(nd2). c)

MORV=−0.9926−0.03882−(SdO)+0.1869·(Ssp3OH)+2.1847·(xp7)+0.34344·(e1C3O2)−0.45767·(c1C2C3)+0.7684·(CKetone) d)

Equation a) is for the malodor trans-3-methyl-2-hexenoic acid (carboxylic acid based malodors).
Equation b) is for the malodor trimethylamine (amine based malodors).
Equation c) is for the malodor 3-mercapto-3-methylhexan-1-ol (thiol based malodors).
Equation d) is for the malodor skatole (indole based malodors).

The program winMolconn (version 1.1.2.1) is used to compute the following set of molecular structure descriptors: c1C1C3d, c1C1O2, c1C2C3, c1C2O2, CaasC, CdCH2, CKetone, dxvp5, dxvp8, dxvp9, e1C2C2d, e1C2O2, e1C3O2, idc, idcbar, idw, knotpv, n2pag22, nd2, SdO, SHCsatu, Ssp3OH, xp7, xvp7, where c1C1C3d is a count of single bonds between a carbon atom with one double bond and two single bonds to non-hydrogen atoms (═C<) and a methyl carbon atom (—CH3), c1C1O2 is a count of single bonds between 5 a methyl (—CH3) carbon atom and an oxygen atom with two single bonds, c1C2C3 is a count of single bonds between a carbon atom with three bonds to non-hydrogen atoms (>CH—) and a methylene (—CH2-) carbon atom, c1C2O2 is a count of single bonds between a methylene (—CH2-) carbon atom and an oxygen atom with two single bonds, CaasC is a count of aromatic carbon atoms single-bonded to one other non-hydrogen atom, CdCH2 is a count of methylene groups (—CH2-), CKetone is account of ketone functional groups, dxvp5 is the valence-corrected difference 5th-order path molecular connectivity index, dxvp8 is the valence-corrected difference 8th-order path molecular connectivity index, dxvp9 is the valence-corrected difference 9th-order path molecular connectivity index, e1C2C2d is the sum of the bond-type electrotopological state index values for single bonds between a carbon atom with one double bond and one single bond to non-hydrogen atoms (═CH—) and a methylene (—CH2-) carbon atom, e1C2O2 is the sum of the bond-type electrotopological state index value for single bonds between a methylene (—CH2-) carbon atom and an oxygen atom with two single bonds, e1C3O2 is the sum of the bond-type electrotopological state index values for single bonds between a carbon atom with three bonds to non-hydrogen atoms (>CH—) and an oxygen atom with two single bonds, idc is a Bonchev-Trinajstic information index, idcbar is a Bonchev-Trinajstic information index, idw is a Bonchev-Trinajstic information index, knotpv is the subgraph distance between xvc3 and xvpc4 where xvc3 is the valence-corrected 3rd-order molecular connectivity index and xvpc4 is the valencecorrected 4th-order path-cluster molecular connectivity index, n2pag22 is the count of path 2 subgraphs with path terminal vertex delta values of 2 and 2, nd2 is the count of vertices with a delta value of 2, SdO is the sum of the electrotopological state index values for sp2 oxygen atoms, SHCsatu is the sum of the hydrogen atom electrotopological state indexes for hydrogen atoms on sp3 carbons that are also bonded to sp2 carbon atoms, Ssp3OH is the sum of the electrotopological state index values for oxygen atoms bonded to sp3 carbon atoms, xp7 is the 7th-order path molecular connectivity index, and xvp7 is the valence-corrected 7th-order path molecular connectivity index.

### Test Methods for Assigning Fragrance Fidelity Index (FFI) and the Blocker Index (BI) for a Malodor Reduction Compound

Blocker materials suitable for use in consumer products of the present invention are chosen for their ability to decrease malodor, while not interfering with perception of a fragrance. Material selection is done by assigning two indices to a test sample material from two reference scales in order to rank odor strengths. The two reference scales are the Fragrance Fidelity Index (FFI) scale and the Blocker Index (BI) scale. The FFI ranks the ability of the test sample material to impart a perceivable odor which could cause interference when combined with another fragrance and the BI ranks the ability of the test sample material to reduce malodor perception. The two methods for assigning the indices to a test sample on the FFI and the BI reference scales are given below.

A. Method for Assigning the FFI to Test Samples

The first step in the method for assigning an FFI to the test samples on the FFI reference scale is to create the FFI reference swatches. The swatches for the scale are created by treating clean fabrics swatches with a known amount of a known concentration of an ethyl vanillin solution. Fabric swatches for this test are white knit polycotton (4 inch×4 inch) swatches from EMC ordered as PC 50/50. The supplier is instructed to strip the swatches first, stripping involves washing twice with a fragrance-free detergent and rinsing three times.

i. Making the FFI Reference Swatches

Make three solutions of ethyl vanillin using a 50%/50% EtOH/water as the diluent at the following concentrations: 25 ppm, 120 ppm and 1000 ppm. Pipette 13 μL of each of the three solutions into the middle of a clean swatch resulting in about a 1 cm diameter of the solution in the middle of the swatch. This will create a sensory scale of three swatches with three different odor levels based on the concentration of the solution pipetted onto the swatch. After drying for 30 minutes in a vented hood, the swatches are wrapped in aluminum foil to prevent odor contamination to the treated swatch. A clean untreated swatch is also included as the lowest anchor point of reference for odor strength on the FFI scale. The FFI reference scale swatches should be used within 0.5 to 12 hours and discarded after 12 hours. The swatches are used as scale anchor points when graders evaluate a test sample(s) and are assigned a Fragrance Fidelity Index (FFI) as show in Table W.

At least four perfumers/expert graders are used to rank the ethyl vanillin swatches in the FFI scale. The perfumer/expert grader needs to demonstrate adequate discrimination on the scale. The perfumer/expert panel is asked to rank order swatches according to a scale between 0 and 3. The panel must demonstrate statistical differences between the swatches.

TABLE W
Results FFI of reference swatches from six perfumers/expert graders.

| | | Expert Grader | | | | | | | |
|---|---|---|---|---|---|---|---|---|---|
| FFI | Swatch | 1 | 2 | 3 | 4 | 5 | 6 | Ave | Std Dev. |
| 0 | Control: stripped swatch NIL | 0 | 0 | 0.5 | 0 | 0 | 0 | 0.08 | 0.2 |
| | ethyl vanillin | | | | | | | | |
| 1 | Stripped swatch with 13 μL 25 ppm | 0.5 | 0.5 | 0.5 | 1.5 | 0.5 | 1.0 | 0.75 | 0.4 |
| | ethyl vanillin | | | | | | | | |
| 2 | Stripped swatch with 13 μL | 2.0 | 1.5 | 1.5 | 2.0 | 2.0 | 2.0 | 1.8 | 0.2 |
| | 120 ppm ethyl vanillin | | | | | | | | |
| 3 | Stripped swatch with 13 μL | 3.0 | 2.0 | 3.0 | 3.0 | 3.0 | 3.0 | 2.8 | 0.4 |
| | 1000 ppm ethyl vanillin | | | | | | | | |

The expert graders must demonstrate a full range of 2.5 over the 4 swatches to be acceptably discriminating. Grader 2 in table W has a range of only 2 and is eliminated from the panel. The panel of expert graders must also demonstrated the ability to statistically discriminate between swatches in the scale.

TABLE X
This table demonstrates acceptable expert graders with an acceptable
range and the panel meets the requirement for discriminating statistics.

| | | Expert Grader | | | | | | |
|---|---|---|---|---|---|---|---|---|
| FFI | Swatch | 1 | 3 | 4 | 5 | 6 | Ave | Std Dev. |
| 0 | Control: stripped | 0 | 0.5 | 0 | 0 | 0 | 0.08 | 0.2 |
| | swatch NIL | | | | | | | |
| | ethyl vanillin | | | | | | | |
| 1 | Stripped swatch with | 0.5 | 0.5 | 1.5 | 0.5 | 1.0 | 0.80 | 0.4 |
| | 13 μL 25 ppm | | | | | | | |
| | ethyl vanillin | | | | | | | |
| 2 | Stripped swatch with | 2.0 | 1.5 | 2.0 | 2.0 | 2.0 | 1.9 | 0.2 |
| | 13 μL 120 | | | | | | | |
| | ppm ethyl vanillin | | | | | | | |
| 3 | Stripped swatch with | 3.0 | 3.0 | 3.0 | 3.0 | 3.0 | 3.0 | 0.0 |
| | 13 μL 1000 ppm | | | | | | | |
| | ethyl vanillin | | | | | | | |

The reference swatches represent the 0, 1, 2, and 3 FFIs on the FFI reference scale, Table Y. The expert grader should familiarize them self with the strength of the odor on the FFI reference swatches by sniffing each one starting at 0 (the lowest odor strength) and ending at 3 (the highest odor strength). This should be done prior to evaluating the test sample material treated swatch.

TABLE Y
Swatch treatments comprising the
Fragrance Fidelity Index (FFI) reference scale

| Swatch treatment | Conc. of ethyl vanillin | FFI |
|---|---|---|
| Clean fabric swatch w/ 13 μL | 1000 ppm ethyl vanillin | 3 |
| ethyl vanillin | | |
| Clean fabric swatch w/ 13 μL | 120 ppm ethyl vanillin | 2 |
| ethyl vanillin | | |
| Clean fabric swatch w/ 13 μL | 25 ppm ethyl vanillin | 1 |
| ethyl vanillin | | |
| Clean fabric swatch NIL ethyl vanillin | NIL ethyl vanillin | 0 |

ii. Making Swatches Treated with the Test Material

A clean swatch is treated with 13 μL of a known concentration of a test sample material resulting in an about 1 cm of the solution on the clean swatch. Just like the reference swatches, the test sample material swatch is dried in a vented hood for 30 minutes and then wrapped in aluminum foil to prevent contamination. The test material swatches and the FFI reference swatches should be made within 2 hrs of each other. The test material swatch must be used within 0.5 to 12 hours and discarded after 12 hours.

iii. Assigning the FFI to the Test Material

At least two perfumers/expert graders are used to assign an FFI grade to a test sample. The perfumer/expert grader smells the test sample swatch by holding that swatch 1 inch from their nose with their nose centered over the area where the test sample was pipetted on to the fabric and then assigns the test sample an FFI grade using the FFI reference scale anchor swatches as references. The test sample swatch is assigned an FFI grade at or between numbers on the FFI scale shown in Table 9. In cases where the test sample material is graded greater than 3, the test material is not a blocker material or the concentration of the material needs to be lowered and reevaluated to determine if a lower level has a malodor blocker functionality.

B. Method for Assigning the BI to Test Sample

The first step in the method for assigning a BI to a test sample material on the BI reference scale is to create the BI reference swatches. The swatches for the scale are created by treating clean fabrics swatches with a known amount of a known volume of isovaleric acid solution at a known concentration. Fabric swatches for this test are white knit polycotton (4 inch×4 inch) swatches from EMC ordered as PC 50/50. The supplier is instructed to strip the swatches first, stripping involves washing twice with a fragrance-free detergent and rinsing three times.

i. Making the BI Reference Swatches

Make one solution of 0.08% isovaleric acid using 50%/50% EtOH/water as the diluent. The BI scale contains one clean swatch with no malodor applied. Three other swatches each have a different volume of the 0.08% isovaleric acid applied. Pipette 2 μL of the 0.08% isovaleric acid solution to one clean swatch, 5 μL of the 0.08% isovaleric acid solution to the next swatch and 20 μL of isovaleric acid to the final clean swatch. These solutions are pipetted to the middle of the swatches. This will create a sensory scale of three swatches with three different odor levels based on the volume of the 0.08% isovaleric acid solution pipetted onto the swatch. After drying for 30 minutes in a vented hood, the swatches are wrapped in aluminum foil to prevent odor contamination to the treated swatch. A clean untreated swatch is also included as the lowest anchor point of reference for malodor strength on the BI scale. The BI reference scale swatches should be used within 0.5 to 12 hours and discarded after 12 hours. The swatches are used as scale anchor points when graders evaluate a test sample(s) and are assigned a Blocker Index (BI). The reference swatches represent the 0, 1, 2, and 3 BIs on the BI reference scale, Table 12. The expert grader should familiarizes him/herself with the strength of the odor on the BI reference swatches by sniffing each one starting at 0 (the lowest odor strength) and ending at 3 (the highest odor strength). This should be done prior to evaluating the swatch treated with the test material.

TABLE Z
Swatch treatments comprising the Blocker Index (BI) reference scale.

| Swatch/treatment | Wt of isovaleric acid | BI |
|---|---|---|
| Clean fabric swatch w/ 20 μL | 16 mg isovaleric acid | 3 |
| 0.08% isovaleric acid | | |
| Clean fabric swatch w/ 5 μL | 4 mg isovaleric acid | 2 |
| 0.08% isovaleric acid | | |
| Clean fabric swatch w/ 2 μL | 1.6 mg isovaleric acid | 1 |
| 0.08% isovaleric acid | | |
| Clean fabric swatch NIL isovaleric acid | NIL isovaleric acid | 0 |

At least four perfumers/expert graders are used to rank the isovaleric acid swatches in the BI scale. The perfumer/expert grader needs to demonstrate adequate discrimination on the scale. The perfumer/expert grader is asked to rank order swatches according to a scale between 0 and 3. The panel of graders must demonstrate statistical differences between the swatches.

Making the Malodorous Swatch and Treating it with a Test Material

To evaluate the BI, the test material is applied to a malodorous swatch to determine how well the test material blocks the malodor. The malodorous swatch is made by treating a clean swatch with 20 μL of a 0.08% solution of isovaleric acid. Dry the malodorous swatch treated with isovaleric acid in a vented hood for 30 minutes. After drying the malodorous swatch a known concentration of test material solution, between 1 ppm and 100 ppm is pipetted onto the malodorous swatch. Apply the test material solution right on top of the spot where the isovaleric acid solution was applied making an about 1 cm diameter spot. Just like the BI reference swatches, the isovaleric acid+test material swatch is dried in a vented hood for 30 minutes and then wrapped in aluminum foil to prevent contamination. The isovaleric acid+test material swatches and the BI reference swatches should be made within 2 hrs of each other. The isovaleric acid+test material swatch must be used between 1-12 hours just like the reference swatches. It is sometimes necessary to evaluate several levels of the test material between about 1 and about 100 ppm to determine the BI.

ii. Assigning the BI to the Test Material

At least two perfumers/expert graders are used to assign the BI to the test sample. The expert grader smells the isovaleric acid+test material swatch by holding that swatch one inch from their nose with their nose centered over the area where the test sample was pipetted on to the fabric and then assigns the isovaleric acid+test material swatch a BI based on ranking its odor strength against the odor strength of the swatches in the BI reference scale. The test sample swatch is assigned a BI at or between numbers on the BI in table. In cases where the isovaleric acid+test material swatch odor is greater than 3 on the BI reference scale, this indicates the material is not a blocker or the concentration of the test material needs to be lowered to achieve its blocker functionality.

### EXAMPLES

The following are illustrative examples of cleaning compositions of the invention and are not intended to be limiting.

### Example 1—Compositions Comprising Malodor Reduction Compounds

In the present disclosure, blends enable more potent malodor reduction because blends are useful at a higher % of the product composition before becoming olfactively noticeable. Below are non-limiting examples of malodor reduction compounds and blends (A-E).

| | | % wt Active | | | | |
|---|---|---|---|---|---|---|
| Component | CAS# | A | B | C | D | E |
| 2,2,8,8-tetramethyl-octahydro-1H- | 29461-14-1 | 35-45 | 15-25 | 5-20 | 10-30 | 15-25 |
| 2,4a-methanonapthalene-10-one | | | | | | |
| 1H-Indene-ar-propanal,2,3- | 300371-33-9 | 10-20 | 1-30 | NIL | 5-10 | 1-5 |
| dihydro-1,1-dimethyl- | | | | | | |
| Hexadecanoic acid, (2E)-3,7- | 3681-73-0 | 35-45 | 10-25 | NIL | 30-40 | 35-50 |
| dimethyl-2,6-octadien-1-yl ester | | | | | | |
| 1-Pentanol-3-methyl-5-phenyl | 55066-48-3 | 10-20 | 10-25 | 2-10 | 5-17 | 10 |
| 4,7-Methano-1H-inden-5-ol, | 171102-41-3 | 0-5 | 10-25 | NIL | 1-6 | 1-5 |
| 3a,4,5,6,7,7a-hexahydro-, 5-acetate | | | | | | |
| 4,8-dimethyl-1-(methylethyl)-7- | N/A | 0-5 | NIL | NIL | NIL | 1-5 |
| oxybiciclo [4.3.0]nonane | | | | | | |
| (3Z)-3,7-dimethylocta-1,3,6-triene | 3338-55-4 | NIL | NIL | 10-20 | 2-5 | NIL |
| 1H-Indene-5-propanal, 2,3- | 173445-65-3 | NIL | NIL | NIL | 7.5-16 | 1-15 |
| dihydro-3,3-dimethyl- | | | | | | |
| 3,4,4a,5,6,7,8,8a- | 4430-31-3 | NIL | NIL | NIL | 3-7 | 1-15 |
| octahydrochromen-2-one | | | | | | |
| 1-(2-tert- | 139504-68-0 | NIL | NIL | NIL | 0.25-1.5 | NIL |
| butylcyclohexyl)oxybutan-2-ol | | | | | | |
| ethyl (2,3,6-trimethylcyclohexyl)carbonate | 93981-50-1 | NIL | NIL | 15-30 | NIL | 2 |
| benzyl 2-hydroxypropanoate | 2051-96-9 | NIL | NIL | 2-5 | NIL | NIL |
| (3,5-dimethylcyclohex-3-en-1- | 67634-16-6 | NIL | NIL | 5-30 | NIL | NIL |
| yl)methanol | | | | | | |
| 2-Dodecanol | 10203-28-8 | NIL | 0.25-1 | NIL | 0.5-3 | NIL |

### Example 2—Compositions Comprising Malodor Reduction Compounds

Below are non-limiting examples of malodor reduction compounds and blends (F-K).

| | | % wt Active | | | | | |
|---|---|---|---|---|---|---|---|
| Ingredient | CAS # | F | G | H | I | J | K |
| (E)-1-(2,6,6-trimethyl-1- | 127-42-4 | 4 | 8 | 2 | 8 | 3 | 2 |
| cyclohex-2-enyl)pent-1-en-3- | | | | | | | |
| one | | | | | | | |
| ethyl dodecanoate | 106-33-2 | NIL | 1 | NIL | 3 | NIL | NIL |
| 3a,4,5,6,7,7a-hexahydro-1H- | 68912-13-0 | 8 | 30 | 1 | 4 | 1 | 3.5 |
| 4,7-methanoinden-1-yl | | | | | | | |
| propanoate | | | | | | | |
| [1R-(1R*,4R*,6R*,10S*)]- | 1139-30-6 | NIL | 0.3 | 2 | 0.5 | NIL | 0.5 |
| 4,12,12-trimethyl-9- | | | | | | | |
| methylene-5- | | | | | | | |
| oxatricyclo[8.2.0.04,6]dodecane | | | | | | | |
| (8E)-cyclohexadec-8-en-1-one | 3100-36-5 | NIL | 5 | NIL | 7 | NIL | NIL |
| 3,5,5-trimethylhexyl acetate | 58430-94-7 | 25 | 15 | 50 | 35 | 60 | 56 |
| ethyl (2,3,6- | 93981-50-1 | NIL | 1 | NIL | 5 | NIL | NIL |
| trimethylcyclohexyl)carbonate | | | | | | | |
| 2,4-dimethyl-4,4a,5,9b- | 27606-09-3 | 25 | 10 | 15 | 15 | 16 | 15 |
| tetrahydroindeno[1,2- | | | | | | | |
| d][1,3]dioxine | | | | | | | |
| 2,2,7,7- | 23787-90-8 | 8 | 9 | 5 | 7 | 5 | 5 |
| tetramethyltricyclo[6.2.1.01,6] | | | | | | | |
| undecan-5-one | | | | | | | |
| (3,5-dimethylcyclohex-3-en- | 67634-16-6 | NIL | 0.7 | NIL | 0.5 | NIL | NIL |
| 1-yl)methanol | | | | | | | |
| 3-(7,7-dimethyl-4- | 33885-52-8 | 30 | 20 | 25 | 15 | 15 | 18 |
| bicyclo[3.1.1]hept-3-enyl)- | | | | | | | |
| 2,2-dimethylpropanal | | | | | | | |
| Total | | 100 | 100 | 100 | 100 | 100 | 100 |

### Example 3—Malodor Reduction Composition

Below in are non-limiting examples of malodor reduction compounds and blends (L-N).

| | | % wt Active | | |
|---|---|---|---|---|
| Ingredient | CAS # | L | M | N |
| 5-Cyclohexadecen-1-One | 37609-25-9 | 15.0 | 2.00 | 2.00 |
| decahydro-2,2,7,7,8,9,9- | 476332-65-7 | 0.005 | 0.01 | 0.01 |
| heptamethylindeno(4,3a- | | | | |
| b)furan | | | | |
| 2,3-Dihydro-5,6-dimethoxy- | 33704-61-9 | 0.3 | 0.5 | 0.5 |
| 2-(4-piperidinylmethylene)- | | | | |
| 1H-inden-1-one | | | | |
| Cedryl Methyl Ether | 19870-74-7 | 6.0 | 10.0 | 4.0 |
| Trans-4-Decenal | 65405-70-1 | 0.005 | 0.002 | 0.002 |
| Decyl Aldehyde | 112-31-2 | 3.74 | 2.0 | 2.0 |
| 3-methyl cyclopentadecenone | 63314-79-4 | 0.4 | 1.0 | 1.0 |
| Diphenyl Oxide | 101-84-8 | 0.5 | 1.0 | 1.0 |
| 3a,4,5,6,7,7a-hexahydro-4,7- | 54830-99-8 | 5.0 | 8.0 | 8.0 |
| methano-1H-indenyl acetate | | | | |
| 3a,4,5,6,7,7a-hexahydro- | 68912-13-0 | 6.0 | 8.0 | 8.0 |
| 1H-4,7-methanoinden- | | | | |
| 1-yl propanoate | | | | |
| 2-(5-methyl-2-propan-2-yl-8- | 68901-32-6 | 10.0 | 15.0 | 15.0 |
| bicyclo[2.2.2]oct-5-enyl)- | | | | |
| 1,3-dioxolane | | | | |
| (E)-3,7-dimethyl-2,6- | 3681-73-0 | 10.0 | 10.0 | 16.0 |
| octadienylhexadecanoate | | | | |
| Iso Nonyl Acetate | 58430-94-7 | 6.65 | 8.0 | 3.0 |
| 2,2,7,7- | 23787-90-8 | 10.0 | 8.0 | 8.0 |
| tetramethyltricyclo[6.2.1.01, | | | | |
| 6]undecan-5-one | | | | |
| (1-Methyl-2-(1,2,2- | 198404-98-7 | 0.1 | 0.3 | 0.3 |
| trimethylbicyclo[3.1.0]-hex-3- | | | | |
| ylmethyl)cyclopropyl) | | | | |
| methanol | | | | |
| Lauric Aldehyde | 112-54-9 | 0.625 | 1.0 | 0.7 |
| Methyl Iso Eugenol | 93-16-3 | 18.000 | 10.0 | 13.0 |
| Methyl hexadecanoate | 112-39-0 | 3.000 | 10.0 | 12.0 |
| 2,3-dihydro-1,1-1H-dimethyl- | 300371-33-9 | 0.400 | 0.0 | 0.3 |
| indene-ar-propanal | | | | |
| 4-tert-butylcyclohexanol | 98-52-2 | 0.400 | 0.1 | 0.1 |
| 2-isobutyl-4-hydroxy-4- | 63500-71-0 | 1.600 | 2.0 | 2.0 |
| methyltetrahydropyran | | | | |
| Undecyl Aldehyde | 112-44-7 | 1.725 | 2.888 | 1.888 |
| Undecylenic Aldehyde | 112-45-8 | 0.550 | 0.2 | 1.2 |
| Total | | 100 | 100.0 | 100.0 |

### Example 4—Malodor Reducting Composition

Below are non-limiting examples of malodor reduction compounds and blends (O-P).

| | Weight % | |
|---|---|---|
| CAS# | O | P |

| | | | |
|---|---|---|---|
| 3-(3,3-dimethyl-2,3-dihydro-1H- | 300371-33-9 | 7.500 | 1.000 |
| inden-5-yl)propanal | | | |
| 3-(6,6-dimethylbicyclo[3.1.1]hept- | 33885-52-8 | 10.000 | NIL |
| 2-en-2-yl)-2,2-dimethylpropanal | | | |
| 3-methyl-5-phenylpentan-1-ol | 55066-48-3 | 10.000 | 49.000 |
| E)-3,7-dimethylocta-2,6-dien-1-yl | 3681-73-0 | 40.000 | 20.000 |
| palmitate | | | |
| 3a,4,5,6,7,7a-hexahydro-4,7- | 5413-60-5 | 4.000 | 15.000 |
| methano-1H-inden-(5 and 6)-yl | | | |
| acetate | | | |
| 3,4,4a,5,6,7,8,8a- | 4430-31-3 | 5.000 | NIL |
| octahydrochromen-2-one | | | |
| 2,2,7,7- | 23787-90-8 | 20.000 | 5.000 |
| tetramethyltricyclo(6.2.1.0(1,6))- | | | |
| undecan-5-one | | | |
| (E)-3,7-dimethylocta-1,3,6-triene | 3338-55-4 | 3.000 | NIL |
| 1-((2-(tert- | 139504-68-0 | 0.500 | 10.000 |
| butyl)cyclohexyl)oxy)butan-2-ol | | | |
| Total | | 100.000 | 100.000 |

The following are examples of cleaning compositions according to the present disclosure.

### Example 5—Heavy Duty Liquid Laundry Detergent Compositions

| | 1 | 2 | 3 | 4 | 5 | 6 | 7 |
|---|---|---|---|---|---|---|---|
| Ingredients | % weight | | | | | | |
| AE_{1.8}S | 6.77 | 5.16 | 1.36 | 1.30 | — | — | — |
| AE₃S | — | — | — | — | 0.45 | — | — |
| LAS | 0.86 | 2.06 | 2.72 | 0.68 | 0.95 | 1.56 | 3.55 |
| HSAS | 1.85 | 2.63 | 1.02 | — | — | — | — |
| AE9 | 6.32 | 9.85 | 10.20 | 7.92 | | | |
| AE8 | | | | | | | 35.45 |
| AE7 | | | | | 8.40 | 12.44 | |
| C₁₂₋₁₄ dimethyl Amine Oxide | 0.30 | 0.73 | 0.23 | 0.37 | — | — | — |
| C₁₂₋₁₈ Fatty Acid | 0.80 | 1.90 | 0.60 | 0.99 | 1.20 | — | 15.00 |
| Citric Acid | 2.50 | 3.96 | 1.88 | 1.98 | 0.90 | 2.50 | 0.60 |
| Optical Brightener 1 | 1.00 | 0.80 | 0.10 | 0.30 | 0.05 | 0.50 | 0.001 |
| Optical Brightener 3 | 0.001 | 0.05 | 0.01 | 0.20 | 0.50 | — | 1.00 |
| Sodium formate | 1.60 | 0.09 | 1.20 | 0.04 | 1.60 | 1.20 | 0.20 |
| DTI 1 | 0.32 | 0.05 | — | 0.60 | 0.10 | 0.60 | 0.01 |
| DTI 2 | 0.32 | 0.10 | 0.60 | 0.60 | 0.05 | 0.40 | 0.20 |
| Sodium hydroxide | 2.30 | 3.80 | 1.70 | 1.90 | 1.70 | 2.50 | 2.30 |
| Monoethanolamine | 1.40 | 1.49 | 1.00 | 0.70 | — | — | — |
| Diethylene glycol | 5.50 | — | 4.10 | — | — | — | — |
| Chelant 1 | 0.15 | 0.15 | 0.11 | 0.07 | 0.50 | 0.11 | 0.80 |
| 4-formyl-phenylboronic acid | — | — | — | — | 0.05 | 0.02 | 0.01 |
| Sodium tetraborate | 1.43 | 1.50 | 1.10 | 0.75 | — | 1.07 | — |
| Ethanol | 1.54 | 1.77 | 1.15 | 0.89 | — | 3.00 | 7.00 |
| Polymer 1 | 0.10 | — | — | — | — | — | 2.00 |
| Polymer 2 | 0.30 | 0.33 | 0.23 | 0.17 | — | — | — |
| Polymer 3 | — | — | — | — | — | — | 0.80 |
| Polymer 4 | 0.80 | 0.81 | 0.60 | 0.40 | 1.00 | 1.00 | — |
| 1,2-Propanediol | — | 6.60 | — | 3.30 | 0.50 | 2.00 | 8.00 |
| Structurant | 0.10 | — | — | — | — | — | 0.10 |
| Perfume | 1.60 | 1.10 | 1.00 | 0.80 | 0.90 | 1.50 | 1.60 |
| Perfume encapsulate | 0.10 | 0.05 | 0.01 | 0.02 | 0.10 | 0.05 | 0.10 |
| Malodour reduction material(s) | 0.10 | 0.05 | 0.01 | 0.02 | 0.10 | 0.05 | 0.10 |
| Protease | 0.80 | 0.60 | 0.70 | 0.90 | 0.70 | 0.60 | 1.50 |
| Mannanase | 0.07 | 0.05 | 0.045 | 0.06 | 0.04 | 0.045 | 0.10 |
| Amylase 1 | 0.30 | — | 0.30 | 0.10 | — | 0.40 | 0.10 |
| Amylase 2 | — | 0.20 | 0.10 | 0.15 | 0.07 | — | 0.10 |
| Xyloglucannase | 0.20 | 0.10 | — | — | 0.05 | 0.05 | 0.20 |
| Lipase | 0.40 | 0.20 | 0.30 | 0.10 | 0.20 | — | — |
| Polishing enzyme | — | 0.04 | — | — | — | 0.004 | — |
| Nuclease | 0.05 | 0.03 | 0.01 | 0.03 | 0.03 | 0.003 | 0.003 |
| Dispersin B | — | — | — | 0.05 | 0.03 | 0.001 | 0.001 |
| Acid Violet 50 | 0.05 | — | — | — | — | — | 0.005 |
| Direct Violet 9 | — | — | — | — | — | 0.05 | — |
| Violet DD | — | 0.035 | 0.02 | 0.037 | 0.04 | — | — |

| | |
|---|---|
| Water, dyes & minors | Balance |
| pH | 8.2 |

Based on total cleaning and/or treatment composition weight. Enzyme levels are reported as raw material.

### Example 6—Unit Dose Compositions

These examples provide various formulations for unit dose laundry detergents. Compositions 8 to 12 comprise a single unit dose compartment. The film used to encapsulate the compositions includes polyvinyl alcohol.

| | 8 | 9 | 10 | 11 | 12 |
|---|---|---|---|---|---|
| Ingredients | % weight | | | | |
| LAS | 19.09 | 16.76 | 8.59 | 6.56 | 3.44 |
| AE3S | 1.91 | 0.74 | 0.18 | 0.46 | 0.07 |
| AE7 | 14.00 | 17.50 | 26.33 | 28.08 | 31.59 |
| Citric Acid | 0.6 | 0.6 | 0.6 | 0.6 | 0.6 |
| C12-15 Fatty Acid | 14.8 | 14.8 | 14.8 | 14.8 | 14.8 |
| Polymer 3 | 4.0 | 4.0 | 4.0 | 4.0 | 4.0 |
| Chelant 2 | 1.2 | 1.2 | 1.2 | 1.2 | 1.2 |
| Optical Brightener 1 | 0.20 | 0.25 | 0.01 | 0.01 | 0.50 |
| Optical Brightener 2 | 0.20 | — | 0.25 | 0.03 | 0.01 |
| Optical Brightener 3 | 0.18 | 0.09 | 0.30 | 0.01 | — |
| DTI 1 | 0.10 | — | 0.20 | 0.01 | 0.05 |
| DTI 2 | — | 0.10 | 0.20 | 0.25 | 0.05 |
| Glycerol | 6.1 | 6.1 | 6.1 | 6.1 | 6.1 |
| Monoethanol amine | 8.0 | 8.0 | 8.0 | 8.0 | 8.0 |
| Tri-isopropanol amine | — | — | 2.0 | — | — |
| Tri-ethanol amine | — | 2.0 | — | — | — |
| Cumene sulfonate | — | — | — | — | 2.0 |
| Protease | 0.80 | 0.60 | 0.07 | 1.00 | 1.50 |
| Mannanase | 0.07 | 0.05 | 0.05 | 0.10 | 0.01 |
| Amylase 1 | 0.20 | 0.11 | 0.30 | 0.50 | 0.05 |
| Amylase 2 | 0.11 | 0.20 | 0.10 | — | 0.50 |
| Polishing enzyme | 0.005 | 0.05 | — | — | — |
| Nuclease | 0.005 | 0.05 | 0.005 | 0.010 | 0.005 |
| Dispersin B | 0.010 | 0.05 | 0.005 | 0.005 | — |
| Cyclohexyl dimethanol | — | — | — | 2.0 | — |
| Acid violet 50 | 0.03 | 0.02 | | | |
| Violet DD | | | 0.01 | 0.05 | 0.02 |
| Structurant | 0.14 | 0.14 | 0.14 | 0.14 | 0.14 |
| Perfume | 1.9 | 1.9 | 1.9 | 1.9 | 1.9 |
| Malodour reduction | 0.9 | 0.03 | 0.05 | 0.1 | 0.005 |
| material(s) | | | | | |

| | |
|---|---|
| Water and miscellaneous | To 100% |
| pH | 7.5-8.2 |

Based on total cleaning and/or treatment composition weight. Enzyme levels are reported as raw material.

In the following examples the unit dose has three compartments, but similar compositions can be made with two, three, four or five compartments. The film used to encapsulate the compartments includes polyvinyl alcohol.

| Base compositions | 13 | 14 | 15 | 16 |
|---|---|---|---|---|
| Ingredients | % weight | | | |
| HLAS | 26.82 | 16.35 | 7.50 | 3.34 |
| AE7 | 17.88 | 16.35 | 22.50 | 30.06 |
| Citric Acid | 0.5 | 0.7 | 0.6 | 0.5 |
| C12-15 Fatty acid | 16.4 | 6.0 | 11.0 | 13.0 |
| Polymer 1 | 2.9 | 0.1 | — | — |
| Polymer 3 | 1.1 | 5.1 | 2.5 | 4.2 |
| Cationic cellulose polymer | — | — | 0.3 | 0.5 |
| Polymer 6 | — | 1.5 | 0.3 | 0.2 |
| Chelant 2 | 1.1 | 2.0 | 0.6 | 1.5 |
| Optical Brightener 1 | 0.20 | 0.25 | 0.01 | 0.005 |
| Optical Brightener 3 | 0.18 | 0.09 | 0.30 | 0.005 |
| DTI 1 | 0.1 | — | 0.2 | — |
| DTI 2 | — | 0.1 | 0.2 | — |
| Glycerol | 5.3 | 5.0 | 5.0 | 4.2 |
| Monoethanolamine | 10.0 | 8.1 | 8.4 | 7.6 |
| Polyethylene glycol | — | — | 2.5 | 3.0 |
| Potassium sulfite | 0.2 | 0.3 | 0.5 | 0.7 |
| Protease | 0.80 | 0.60 | 0.40 | 0.80 |
| Amylase 1 | 0.20 | 0.20 | 0.200 | 0.30 |
| Polishing enzyme | — | — | 0.005 | 0.005 |
| Nuclease | 0.05 | 0.010 | 0.005 | 0.005 |
| Dispersin B | — | 0.010 | 0.010 | 0.010 |
| MgCl₂ | 0.2 | 0.2 | 0.1 | 0.3 |
| Structurant | 0.2 | 0.1 | 0.2 | 0.2 |
| Acid Violet 50 | 0.04 | 0.03 | 0.05 | 0.03 |
| Perfume | 0.10 | 0.30 | 0.01 | 0.05 |

| | |
|---|---|
| Solvents and misc. | To 100% |
| pH | 7.0-8.2 |

| Finishing compositions | 17 | | | 18 | | |
|---|---|---|---|---|---|---|
| Compartment | A | B | C | A | B | C |
| Volume of each compartment | 40 ml | 5 ml | 5 ml | 40 ml | 5 ml | 5 ml |
| Ingredients | Active material in Wt. % | | | | | |
| Perfume | 1.6 | 1.6 | 1.6 | 1.6 | 1.6 | 1.6 |
| Malodour reduction | 0.1 | 0.01 | 0.005 | 0.3 | 0.6 | 0.9 |
| material(s) | | | | | | |
| Violet DD | 0 | 0.006 | 0 | 0 | 0.004 | — |
| TiO2 | — | — | 0.1 | — | | 0.1 |
| Sodium Sulfite | 0.4 | 0.4 | 0.4 | 0.3 | 0.3 | 0.3 |
| Polymer 5 | — | | | 2 | — | — |
| Hydrogenated castor oil | 0.14 | 0.14 | 0.14 | 0.14 | 0.14 | 0.14 |

| | |
|---|---|
| Base Composition 13, 14, | Add to 100% |
| 15 or 16 | |

Based on total cleaning and/or treatment composition weight, enzyme levels are reported as raw material.

### Example 7—Granular Laundry Detergent Compositions for Hand Washing or Washing Machines, Typically Top-Loading Washing Machines

| | 19 | 20 | 21 | 22 | 23 | 24 |
|---|---|---|---|---|---|---|
| Ingredient | % weight | | | | | |
| LAS | 11.33 | 10.81 | 7.04 | 4.20 | 3.92 | 2.29 |
| Quaternary ammonium | 0.70 | 0.20 | 1.00 | 0.60 | — | — |
| AE3S | 0.51 | 0.49 | 0.32 | — | 0.08 | 0.10 |
| AE7 | 8.36 | 11.50 | 12.54 | 11.20 | 16.00 | 21.51 |
| Sodium Tripolyphosphate | 5.0 | — | 4.0 | 9.0 | 2.0 | — |
| Zeolite A | — | 1.0 | — | 1.0 | 4.0 | 1.0 |
| Sodium silicate 1.6R | 7.0 | 5.0 | 2.0 | 3.0 | 3.0 | 5.0 |
| Sodium carbonate | 20.0 | 17.0 | 23.0 | 14.0 | 14.0 | 16.0 |
| Polyacrylate MW 4500 | 1.0 | 0.6 | 1.0 | 1.0 | 1.5 | 1.0 |
| Polymer 6 | 0.1 | 0.2 | — | — | 0.1 | — |
| Carboxymethyl cellulose | 1.0 | 0.3 | 1.0 | 1.0 | 1.0 | 1.0 |
| Acid Violet 50 | 0.05 | — | 0.02 | — | 0.04 | — |
| Violet DD | — | 0.03 | — | 0.03 | — | 0.03 |
| Protease 2 | 0.10 | 0.10 | 0.10 | 0.10 | — | 0.10 |
| Amylase | 0.03 | — | 0.03 | 0.03 | 0.03 | 0.03 |
| Lipase | 0.03 | 0.07 | 0.30 | 0.10 | 0.07 | 0.40 |
| Polishing enzyme | 0.002 | — | 0.05 | — | 0.02 | — |
| Nuclease | 0.001 | 0.001 | 0.01 | 0.05 | 0.002 | 0.02 |
| Dispersin B | 0.001 | 0.001 | 0.05 | — | 0.001 | — |
| Optical Brightener 1 | 0.200 | 0.001 | 0.300 | 0.650 | 0.050 | 0.001 |
| Optical Brightener 2 | 0.060 | — | 0.650 | 0.180 | 0.200 | 0.060 |
| Optical Brightener 3 | 0.100 | 0.060 | 0.050 | — | 0.030 | 0.300 |
| Chelant 1 | 0.60 | 0.80 | 0.60 | 0.25 | 0.60 | 0.60 |
| DTI 1 | 0.32 | 0.15 | 0.15 | — | 0.10 | 0.10 |
| DTI 2 | 0.32 | 0.15 | 0.30 | 0.30 | 0.10 | 0.20 |
| Sodium Percarbonate | — | 5.2 | 0.1 | — | — | — |
| Sodium Perborate | 4.4 | — | 3.85 | 2.09 | 0.78 | 3.63 |
| Nonanoyloxybenzensulfonate | 1.9 | 0.0 | 1.66 | 0.0 | 0.33 | 0.75 |
| Tetraacetylehtylenediamine | 0.58 | 1.2 | 0.51 | 0.0 | 0.015 | 0.28 |
| Photobleach | 0.0030 | 0.0 | 0.0012 | 0.0030 | 0.0021 | — |
| S-ACMC | 0.1 | 0.0 | 0.0 | 0.0 | 0.06 | 0.0 |
| Malodour reduction material(s) | 0.09 | 0.01 | 0.66 | 0.06 | 0.1 | 0.005 |

| | |
|---|---|
| Sulfate/Moisture | Balance |

### Example 8—Granular Laundry Detergent Compositions Typically for Front-Loading Automatic Washing Machines

| | 25 | 26 | 27 | 28 | 29 | 30 |
|---|---|---|---|---|---|---|
| Ingredient | % weight | | | | | |
| LAS | 6.08 | 5.05 | 4.27 | 3.24 | 2.30 | 1.09 |
| AE3S | — | 0.90 | 0.21 | 0.18 | — | 0.06 |
| AS | 0.34 | — | — | — | — | — |
| AE7 | 4.28 | 5.95 | 6.72 | 7.98 | 9.20 | 10.35 |
| Quaternary ammonium | 0.5 | — | — | 0.3 | — | — |
| Crystalline layered silicate | 4.1 | — | 4.8 | — | — | — |
| Zeolite A | 5.0 | — | 2.0 | — | 2.0 | 2.0 |
| Citric acid | 3.0 | 4.0 | 3.0 | 4.0 | 2.5 | 3.0 |
| Sodium carbonate | 11.0 | 17.0 | 12.0 | 15.0 | 18.0 | 18.0 |
| Sodium silicate 2R | 0.08 | — | 0.11 | — | — | — |
| Optical Brightener 1 | — | 0.25 | 0.05 | 0.01 | 0.10 | 0.02 |
| Optical Brightener 2 | — | — | 0.25 | 0.20 | 0.01 | 0.08 |
| Optical Brightener 3 | — | 0.06 | 0.04 | 0.15 | — | 0.05 |
| DTI 1 | 0.08 | — | 0.04 | — | 0.10 | 0.01 |
| DTI 2 | 0.08 | — | 0.04 | 0.10 | 0.10 | 0.02 |
| Soil release agent | 0.75 | 0.72 | 0.71 | 0.72 | — | — |
| Acrylic/maleic acid copolymer | 1.1 | 3.7 | 1.0 | 3.7 | 2.6 | 3.8 |
| Carboxymethyl cellulose | 0.2 | 1.4 | 0.2 | 1.4 | 1.0 | 0.5 |
| Protease 3 | 0.20 | 0.20 | 0.30 | 0.15 | 0.12 | 0.13 |
| Amylase 3 | 0.20 | 0.15 | 0.20 | 0.30 | 0.15 | 0.15 |
| Lipase | 0.05 | 0.15 | 0.10 | — | — | — |
| Amylase 2 | 0.03 | 0.07 | — | — | 0.05 | 0.05 |
| Cellulase 2 | — | — | — | — | 0.10 | 0.10 |
| Polishing enzyme | 0.003 | 0.005 | 0.020 | — | — | — |
| Nuclease | 0.002 | 0.010 | 0.020 | 0.020 | 0.010 | 0.003 |
| Dispersin B | 0.002 | 0.010 | 0.020 | 0.020 | 0.010 | 0.002 |
| Tetraacetylehtylenediamine | 3.6 | 4.0 | 3.6 | 4.0 | 2.2 | 1.4 |
| Sodium percabonate | 13.0 | 13.2 | 13.0 | 13.2 | 16.0 | 14.0 |
| Chelant 3 | — | 0.2 | — | 0.2 | — | 0.2 |
| Chelant 2 | 0.2 | — | 0.2 | — | 0.2 | 0.2 |
| MgSO₄ | — | 0.42 | — | 0.42 | — | 0.4 |
| Perfume | 0.5 | 0.6 | 0.5 | 0.6 | 0.6 | 0.6 |
| Malodour reduction material(s) | 0.05 | 0.1 | 0.005 | 0.2 | 0.02 | 0.1 |
| Suds suppressor agglomerate | 0.05 | 0.10 | 0.05 | 0.10 | 0.06 | 0.05 |
| Soap | 0.45 | 0.45 | 0.45 | 0.45 | — | — |
| Acid Violet 50 | 0.04 | — | 0.05 | — | 0.04 | — |
| Violet DD | — | 0.04 | — | 0.05 | — | 0.04 |
| S-ACMC | 0.01 | 0.01 | — | 0.01 | — | — |
| Direct Violet 9 (active) | — | — | 0.0001 | 0.0001 | — | — |

| | |
|---|---|
| Sulfate/Water & Miscellaneous | Balance |

AE1.8S is C₁₂₋₁₅ alkyl ethoxy (1.8) sulfate
AE3S is C₁₂₋₁₅ alkyl ethoxy (3) sulfate
AE7 is C₁₂₋₁₃ alcohol ethoxylate, with an average degree of ethoxylation of 7
AE8 is C₁₂₋₁₃ alcohol ethoxylate, with an average degree of ethoxylation of 8
AE9 is C₁₂₋₁₃ alcohol ethoxylate, with an average degree of ethoxylation of 9
Amylase 1 is Stainzyme®, 15 mg active/g
Amylase 2 is Natalase®, 29 mg active/g
Amylase 3 is Stainzyme Plus®, 20 mg active/g,
AS is C₁₂₋₁₄ alkylsulfate
Cellulase 2 is Celluclean™, 15.6 mg active/g
Xyloglucanase is Whitezyme®, 20 mg active/g
Chelant 1 is diethylene triamine pentaacetic acid
Chelant 2 is 1-hydroxyethane 1,1-diphosphonic acid
Chelant 3 is sodium salt of ethylenediamine-N,N′-disuccinic acid, (S,S) isomer (EDDS)
Dispersin B is a glycoside hydrolase, reported as 1000 mg active/g
DTI 1 is poly(4-vinylpyridine-1-oxide) (such as Chromabond S-403E®),
DTI 2 is poly(1-vinylpyrrolidone-co-1-vinylimidazole) (such as Sokalan HP56®).
HSAS is mid-branched alkyl sulfate as disclosed in U.S. Pat. No. 6,020,303 and U.S. Pat. No. 6,060,443
LAS is linear alkylbenzenesulfonate having an average aliphatic carbon chain length C₉-C₁₅ (HLAS is acid form).
Lipase is Lipex®, 18 mg active/g
Malodour reduction is as described in the present disclosure material
Mannanase is Mannaway®, 25 mg active/g
Nuclease is a Phosphodiesterase SEQ ID NO 1, reported as 1000 mg active/g
Optical Brightener 1 is disodium 4,4′-bis{[4-anilino-6-morpholino-s-triazin-2-yl]-amino}-2,2′-stilbenedisulfonate
Optical Brightener 2 is disodium 4,4′-bis-(2-sulfostyryl)biphenyl (sodium salt)
Optical Brightener 3 is Optiblanc SPL10® from 3V Sigma
Perfume encapsulate is a core-shell melamine formaldahyde perfume microcapsule.
Photobleach is a sulfonated zinc phthalocyanine
Polishing enzyme is Para-nitrobenzyl esterase, reported as 1000 mg active/g
Polymer 1 is bis((C₂H₅O)(C₂H₄O)n)(CH₃)—N⁺—CₓH₂ₓ—N⁺—(CH₃)-bis((C₂H₅O)(C₂H₄O)n), wherein n=20-30, x=3 to 8 or sulfated or sulfonated variants thereof
Polymer 2 is ethoxylated (EO₁₅) tetraethylene pentamine
Polymer 3 is ethoxylated polyethylenimine
Polymer 4 is ethoxylated hexamethylene diamine
Polymer 5 is Acusol 305, provided by Rohm & Haas
Polymer 6 is a polyethylene glycol polymer grafted with vinyl acetate side chains, provided by BASF.
Protease is Purafect Prime®, 40.6 mg active/g
Protease 2 is Savinase®, 32.89 mg active/g
Protease 3 is Purafect®, 84 mg active/g
Quaternary ammonium is C₁₂₋₁₄ Dimethylhydroxyethyl ammonium chloride
S-ACMC is Reactive Blue 19 Azo-CM-Cellulose provided by Megazyme
Soil release agent is Repel-o-tex® SF2
Structurant is Hydrogenated Castor Oil
Violet DD is a thiophene azo dye provided by Milliken

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cleaning composition comprising:
a nuclease enzyme; and
one or more malodor reduction materials.

2. A cleaning composition according to claim 1, wherein the nuclease enzyme is a deoxyribonuclease enzyme, a ribonuclease enzyme, or a mixture thereof.

3. A cleaning composition according to claim 1, wherein the nuclease enzyme is selected from any of E.C. classes E.C. 3.1.21.x (where x=1, 2, 3, 4, 5, 6, 7, 8, 9), 3.1.22.y (where y=1, 2, 4, 5), E.C. 3.1.30.z (where z=1, 2) or E.C. 3.1.31.1, or mixtures thereof, preferably from E.C. 3.1.21, preferably E.C. 3.1.21.1.

4. A cleaning composition according to claim 1, wherein the nuclease enzyme comprises a deoxyribonuclease enzyme.

5. A cleaning composition according to claim 1, in which the enzyme comprises an enzyme having both RNase and DNase activity, preferably being from E.C. 3.1.30.2.

6. A cleaning composition according to claim 1, wherein the nuclease enzyme is a microbial enzyme, preferably a bacterial enzyme.

7. A cleaning composition according to claim 1, wherein the enzyme has an amino acid sequence having at least 85%, or at least 90 or at least 95% or even 100% identity with the amino acid sequence shown in SEQ ID NO:1, SEQ ID NO:2 or SEQ ID NO:3.

8. A cleaning composition according to claim 1, wherein the composition further comprises a β-N-acetylglucosaminidase enzyme from E.C. 3.2.1.52, preferably an enzyme having at least 70% identity to SEQ ID NO:4.

9. A cleaning composition according to claim 1, wherein the cleaning composition comprises a sum total of from about 0.00025% to about 0.5%, by weight of the cleaning composition, of one or more malodor reduction materials.

10. A cleaning composition according to claim 1, wherein said one or more malodor reduction material has a MORV of at least 0.5, preferably from 0.5 to 10, more preferably from 1 to 10, most preferably from 1 to 5, as determined by the test methods described herein.

11. A cleaning composition according to claim 1, wherein the cleaning composition comprises at least one, preferably all, of the one or more malodor reduction materials has a Universal MORV.

12. A cleaning composition according to claim 1, wherein the sum total of the one or more malodor reduction materials in the cleaning composition has a Blocker Index of less than 3, more preferable less than about 2.5, even more preferably less than about 2, and still more preferably less than about 1, and most preferably about 0.

13. A cleaning composition according to claim 1, wherein the one or more malodor reduction material has a Fragrance Fidelity Index of less than 3, preferably less than 2, more preferably less than 1, and most preferably about 0.

14. A cleaning composition according to claim 1, wherein one or more malodor reduction materials has a log P greater than about 3, preferably greater than about 3 but less than about 8.

15. A cleaning composition according to claim 1, wherein one or more malodor reduction materials has a vapor pressure of greater than about 0.01 torr, preferably greater than about 0.01 torr to about 10 torr.

16. A cleaning composition according to claim 1, wherein the one or more malodor reduction materials is selected from the group consisting of: 2,4-dimethyl-2-(5,5,8,8-tetramethyl-5,6,7,8-tetrahydronaphthalen-2-yl)-1,3-dioxolane; 3-methoxy-7,7-dimethyl-10-methylenebicyclo[4.3.1]decane; Oxybenzone; Oxyoctaline formate; 3a,5,6,7,8,8b-hexahydro-2,2,6,6,7,8,8-heptamethyl-4H-indeno(4,5-d)-1,3-dioxole; 3a,5,6,7,8,8b-hexahydro-2,2,6,6,7,8,8-heptamethyl-4H-indeno(4,5-d)-1,3-dioxole; 2,2,6,8-tetramethyl-1,2,3,4,4a,5,8,8a-octahydronaphthalen-1-ol; Nootkatone; 1-ethyl-3-methoxytricyclo[2.2.1.02,6]heptane; 10-isopropyl-2,7-dimethyl-1-oxaspiro[4.5]deca-3,6-diene; Methyl stearate; Methyl linoleate; Methyl isoeugenol; Methyl eugenol; 2,4-dimethyl-4,4a,5,9b-tetrahydroindeno[1,2-d][1,3]dioxine; 4-(4-hydroxy-4-methylpentyl)cyclohex-3-ene-1-carbaldehyde; (Z)-3-hexen-1-yl-2-cyclopenten-1-one; (2,5-dimethyl-1,3-dihydroinden-2-yl)methanol; Khusimol; (1-methyl-2-((1,2,2-trimethylbicyclo[3.1.0]hexan-3-yl)methyl)cyclopropyl)methanol; 2,6,9,10-tetramethyl-1-oxaspiro(4.5)deca-3,6-diene; Isopropyl palmitate; Isopimpinellin; Iso3-methylcyclopentadecan-1-one; Isoeugenyl benzyl ether; 1-((2S,3S)-2,3,8,8-tetramethyl-1,2,3,4,5,6,7,8-octahydronaphthalen-2-yl)ethan-1-one; Isobornylcyclohexanol; Isobornyl propionate; Isobornyl isobutyrate; Isobornyl cyclohexanol; Isobergamate; Hydroxymethyl isolongifolene; 2,3-dihydro-3,3-dimethyl-1H-indene-5-propanal; 3-(3,3-dimethyl-2,3-dihydro-1H-inden-5-yl)propanal; 3a,4,5,6,7,7a-hexahydro-1H-4,7-methanoinden-6-yl acetate; Guaiol; gamma-Muurolene; gamma-Himachalene; gamma-Eudesmol; gamma-Cadinene; 4,6,6,7,8,8-hexamethyl-1,3,4,6,7,8-hexahydrocyclopenta[g]isochromene; 8,8-dimethyl-3a,4,5,6,7,7a-hexahydro-1H-4,7-methanoinden-6-yl propionate; (Z)-6-ethylideneoctahydro-2H-5,8-methanochromen-2-one; (E)-4-((3aR,4R,7R,7aR)-1,3a,4,6,7,7a-hexahydro-5H-4,7-methanoinden-5-ylidene)-3-methylbutan-2-ol; 8,8-dimethyl-3a,4,5,6,7,7a-hexahydro-1H-4,7-methanoinden-6-yl acetate; 3-(4-ethylphenyl)-2,2-dimethylpropanenitrile; 1-cyclopentadec-4-en-1-one; 1-cyclopentadec-4-en-1-one; Eugenyl acetate; 6-ethyl-2,10,10-trimethyl-1-oxaspiro[4.5]deca-3,6-diene; (E)-4-((3aS,7aS)-octahydro-5H-4,7-methanoinden-5-ylidene)butanal; Octahydro-1H-4,7-methanoinden-5-yl acetate; delta-Cadinene; delta-Amorphene; Decyl anthranilate; 3a,4,5,6,7,7a-hexahydro-1H-4,7-methanoinden-6-yl butyrate; 3a,4,5,6,7,7a-hexahydro-1H-4,7-methanoinden-5-ylisobutyrate; Curzerene; (E)-cycloheptadec-9-en-1-one; (Z)-3-methyl-2-(pent-2-en-1-yl)cyclopent-2-en-1-one; (E)-1-(2,6,6-trimethylcyclohex-2-en-1-yl)hepta-1,6-dien-3-one; (3aR,5aR,9aR,9bR)-3a,6,6,9a-tetramethyldodecahydronaphtho[2,1-b]furan; Cedryl methyl ether; Cedryl formate; Cedryl acetate; (4Z,8Z)-1,5,9-trimethyl-13-oxabicyclo[10.1.0]trideca-4,8-diene; Cedrol; 5-methyl-1-(2,2,3-trimethylcyclopent-3-en-1-yl)-6-oxabicyclo[3.2.1]octane; 1,1,2,3,3-pentamethyl-1,2,3,5,6,7-hexahydro-4H-inden-4-one; Caryophyllene alcohol acetate; Caryolan-1-ol; Bornyl isobutyrate; beta-Santalol; beta-Patchoulline; beta-Himachalene Oxide; beta-Himachalene; beta-Guaiene; (2,2-dimethoxyethyl)benzene; beta-Copaene; beta-Cedrene; beta-Caryophyllene; Bergaptene; Benzyl laurate; 2′-isopropyl-1,7,7-trimethylspiro[bicyclo[2.2.1]heptane-2,4′-[1,3]dioxane]; Anisyl phenylacetate; (3aR,5aS,9aS,9bR)-3a,6,6,9a-tetramethyldodecahydronaphtho[2,1-b]furan; (4aR,5R,7aS,9R)-2,2,5,8,8,9a-hexamethyloctahydro-4H-4a,9-methanoazuleno[5,6-d][1,3]dioxole; 2,5,5-trimethyl-1,2,3,4,5,6,7,8-octahydronaphthalen-2-ol; (3S,5aR,7aS,11aS,11bR)-3,8,8,11a-tetramethyldodecahydro-5H-3,5a-epoxynaphtho[2,1-c]oxepine; 2,2,6,6,7,8,8-heptamethyldecahydro-2H-indeno[4,5-b]furan; alpha-Vetivone; alpha-Santalol; alpha-Patchoulene; alpha-Muurolene; alpha-methyl ionone; alpha-Gurjunene; alpha-Eudesmol; alpha-Cubebene; alpha-Cedrene epoxide; alpha-Cadinol; alpha-Cadinene; alpha-Bisabolol; alpha-Amorphene; alpha-Agarofuran; Allo-aromadendrene; Acetoxymethyl-isolongifolene (isomers); Acetarolle; (Z)-2-(4-methylbenzylidene)heptanal; 7-eip-alpha-Eudesmol; 7-Acetyl-1,1,3,4,4,6-hexamethyltetralin; 5-Cyclohexadecenone; 4-(p-Methoxyphenyl)-2-butanone; 3-Thujopsanone; 2,6-Nonadien-1-ol; 10-epi-gamma-Eudesmol; 1,1,2,3,3-Pentamethylindan; (2S,5S,6S)-2,6,10,10-tetramethyl-1-oxaspiro[4_5]decan-6-ol; 2-(8-isopropyl-6-methylbicyclo[2.2.2]oct-5-en-2-yl)-1,3-dioxolane; 3a,4,5,6,7,7a-hexahydro-1H-4,7-methanoinden-6-yl propionate; Bulnesol; Benzoin; 5-Acetyl-1,1,2,3,3,6-hexamethylindan; Patchouli alcohol; Perillyl alcohol; Phenethyl phenylacetate; Phenoxanol; 3a,4,5,6,7,7a-hexahydro-1H-4,7-methanoinden-6-yl pivalate; p-Tolyl phenylacetate; (2R,4a′R,8a′R)-3,7′-dimethyl-3′,4′,4a′,5′,8′,8a′-hexahydro-1′H-spiro[oxirane-2,2′-[1,4]methanonaphthalene]; (Z)-6-ethylideneoctahydro-2H-5,8-methanochromene; 2,2,7,9-tetramethylspiro(5.5)undec-8-en-1-one; 3-methyl-5-(2,2,3-trimethylcyclopent-3-en-1-yl)pentan-2-ol; (Z)-2-ethyl-4-(2,2,3-trimethylcyclopent-3-en-1-yl)but-2-en-1-ol; 5-methoxyoctahydro-1H-4,7-methanoindene-2-carbaldehyde; Sclareol; Sclareol oxide; Selina-3,7(11)-diene; Spathulenol; 1-(spiro[4.5]dec-7-en-7-yl)pent-4-en-1-one; tau-Cadinol; tau-Muurolol; Thujopsene; 1-(2,2,6-trimethylcyclohexyl)hexan-3-ol; Tricyclone; Methyl 2-((1-hydroxy-3-phenylbutyl)amino)benzoate; Decahydro-2,6,6,7,8,8-hexamethyl-2h-indeno(4,5-b)furan; Valencene; Valerianol; 1-methoxy-3a,4,5,6,7,7a-hexahydro-1H-4,7-methanoindene; 1-((3R,3aR,7R,8aS)-3,6,8,8-tetramethyl-2,3,4,7,8,8a-hexahydro-1H-3a,7-methanoazulen-5-yl)ethan-1-one; Methyl (Z)-2-(((2,4-dimethylcyclohex-3-en-1-yl)methylene)amino)benzoate; Vetiverol; Vetivert Acetate; Decahydro-3H-spiro[furan-2,5′-[4,7]methanoindene]; (Z)-cyclooct-4-en-1-yl methyl carbonate; (1aR,4S,4aS,7R,7aS,7bS)-1,1,4,7-tetramethyldecahydro-1H-cyclopropa[e]azulen-4-ol; 3,5,5,6,7,8,8-heptamethyl-5,6,7,8-tetrahydronaphthalene-2-carbonitrile; (1S,2S,3S,5R)-2,6,6-trimethylspiro[bicyclo[3.1.1]heptane-3,1′-cyclohexan]-2′-en-4′-one; 1′,1′,5′,5′-tetramethylhexahydro-2′H,5′H-spiro[[1,3]dioxolane-2,8′-[2,4a]methanonaphthalene]; 1′,1′,5′,5′-tetramethylhexahydro-2′H,5′H-spiro[[1,3]dioxolane-2,8′-[2,4a]methanonaphthalene] K; 4-(4-hydroxy-3-methoxyphenyl)butan-2-one; (1R,8aR)-4-isopropyl-1,6-dimethyl-1,2,3,7,8,8a-hexahydronaphthalene; 4,5-epoxy-4,11,11-trimethyl-8-methylenebicyclo(7.2.0)undecane; 1,3,4,6,7,8alpha-hexahydro-1,1,5,5-tetramethyl-2H-2,4alpha-methanophtalen-8(5H)-one; 1-(2,2-dimethyl-6-methylen cyclohexyl)-1-penten-3-one; and combinations thereof.

17. A cleaning composition according to claim 1, wherein the one or more malodor reduction materials is selected from the group consisting of: 3-(3,3-dimethyl-2,3-dihydro-1H-inden-5-yl)propanal; 3-(6,6-dimethylbicyclo[3.1.1]hept-2-en-2-yl)-2,2-dimethylpropanal; 3-methyl-5-phenylpentan-1-ol; E)-3,7-dimethylocta-2,6-dien-1-yl palmitate; 3a,4,5,6,7,7a-hexahydro-4,7-methano-1H-inden-(5 and 6)-yl acetate; 3,4,4a,5,6,7,8,8a-octahydrochromen-2-one; 2,2,7,7-tetramethyltricyclo(6.2.1.0(1,6))-undecan-5-one; (E)-3,7-dimethylocta-1,3,6-triene; 1-((2-(tert-butyl)cyclohexyl)oxy)butan-2-ol; and combinations thereof.

18. A cleaning composition according to claim 1, wherein cleaning composition further comprises a perfume.

19. A cleaning composition according to claim 18, wherein the weight ratio of parts of malodor reduction composition to parts of perfume may be from about 1:20,000 to about 3000:1, preferably from about 1:10,000 to about 1,000:1, more preferably from about 5,000:1 to about 500:1, and most preferably from about 1:15 to about 1:1.

20. A cleaning composition according to claim 1, wherein the cleaning composition further comprises from about 1% to about 80%, by weight of the cleaning composition, of a surfactant system.

21. A cleaning composition according to claim 19, wherein the surfactant system comprises an anionic surfactant, preferably selected from the group consisting of alkyl sulfate, alkyl alkoxy sulfate, alkyl benzene sulfonate, paraffin sulfonate, and mixtures thereof.

22. A method of cleaning a surface, preferably a textile, comprising mixing the cleaning composition according to claim 1 with water to form an aqueous liquor and contacting a surface, preferably a textile, with the aqueous liquor in a laundering step.

23. The use of one or more malodor reducing materials in a cleaning composition to enhance the malodor-reducing benefits of a nuclease enzyme.
